(19) United States
(12) Patent Application Publication
(10) Pub. No.: US 2025/0131902 A1
(43) Pub. Date: Apr. 24, 2025

(54) MULTI-PANEL STRUCTURE FOR ATTENUATING TRANSMITTED SOUND

(71) Applicants: Vedant Prakul Chhabra, Mason, OH (US); Molly Vedika Chhabra, Mason, OH (US)

(72) Inventors: Vedant Prakul Chhabra, Mason, OH (US); Molly Vedika Chhabra, Mason, OH (US)

(21) Appl. No.: 18/919,423

(22) Filed: Oct. 17, 2024

Related U.S. Application Data
(60) Provisional application No. 63/591,121, filed on Oct. 18, 2023.

(51) Int. Cl. G10K 11/00

(52) U.S. Cl. CPC G10K 11/002

(57) ABSTRACT

The present disclosure introduces a multi-panel structure designed to effectively attenuate sound transmission. The structure comprises a series of panels and absorbers arranged alternately. The panels are constructed from continuous and uninterrupted materials, with at least one panel incorporating a meta-material possessing metallic substance and specific properties. The absorbers feature porous materials with solid and fluid components, and in some cases, may also include meta-materials with solid and fluid components. The panels and absorbers possess optimized characteristics for sound attenuation, such as average bulk density, elastic modulus, and the damping ratio. Recycled materials can be utilized, promoting environmentally friendly construction without compromising sound-blocking capabilities. Additionally, the present disclosure further comprises a computer-implemented method utilizing artificial intelligence models for designing multi-panel structures and a computer simulation method for generating internal structures and compositions to attenuate sound transmission. This innovative solution provides an efficient approach to soundproofing applications.

### FIELD OF THE INVENTION

The present disclosure is broadly directed to developing multi-panel structures for attenuating transmitted sound incident on them. Computer-implemented methods of designing the multi-panel structures are also disclosed.

### BACKGROUND

With the ever-increasing prevalence of constant loud traffic and other noises surpassing the World Health Organization's safe limit of 45 dB, millions of Americans residing near homes, schools, and workplaces are exposed to detrimental sound levels. This has led to significant health concerns, particularly for children attending schools situated in high-noise environments. Studies have shown that such exposure contributes to heightened stress levels, lower academic performance, hyperactivity, and can be especially detrimental to children with hearing impairments or on the autism spectrum. The detrimental effects of noise pollution on public health necessitate the implementation of effective measures to protect individuals from these impacts.

Currently available materials and structural designs have not adequately addressed the problem of noise pollution. Many individuals residing near highways, busy cities, and urban areas continue to experience stress, high blood pressure, speech interference, sleep disturbances, and reduced productivity due to noise pollution. Although some research has been conducted on meta-materials, the focus has predominantly been on exotic materials that are neither environmentally friendly nor cost-effective. Furthermore, typical housing structures in countries lack insulation and employ single panel designs that offer minimal soundproofing capabilities. Even high-end homes in such regions are not adequately equipped to mitigate noise-related issues.

Various prior art references exist in the field of using meta-materials for sound reduction. U.S. Pat. No. 10,043,508, and China Patent Publications 115320190A, 114446273A, 114045949A, and 113799450A, which are included herein by reference, disclose meta-materials for sound reduction. However, these many of these references primarily focus on creating structured meta-materials with their comprising components arranged in specific arrangements in a grid or cellular manner and/or the meta-materials are not continuous and have perforations, apertures, or holes. The present disclosure seeks to overcome the limitations of existing sound-blocking materials by introducing a multi-panel structure that utilizes novel meta-materials to achieve desired sound attenuation properties across a wide range of incident frequencies. In broad terms, the meta-materials of the present disclosure are substantially continuous and uninterrupted, and have comprising elements that are arranged in no particular arrangement and their spatial positioning is not predetermined.

The present disclosure aims to provide a broad set of solutions to the aforementioned problems by introducing a multi-panel structure designed to attenuate transmitted sound. The present disclosure broadly incorporates meta-materials comprising metallic substances, recycled materials, and environmentally friendly components. By utilizing a combination of recycled metal shavings, turnings, and scraps, as well as recycled materials, embodiments of the present disclosure not only reduce noise pollution but also promote sustainability. The present disclosure focuses on the development of a multi-panel structure to have specific physical properties such as bulk density, elastic modulus, and the damping ratio, which contribute to their sound attenuation capabilities.

The present disclosure largely recognizes the detrimental effects of noise pollution and aims to provide an affordable and sustainable solution. By incorporating environmentally friendly and recycled materials in the construction of the meta-materials, the present disclosure broadly promotes soundproofing without exacerbating climate-related concerns.

In conclusion, the present disclosure offers a novel solution to the endemic problem of noise pollution by introducing a multi-panel structure utilizing meta-materials. This invention generally aims to provide individuals, including children, with a soundproofing solution that reduces the negative impacts of noise pollution on their health and well-being, all while using environmentally friendly and cost-effective materials.

### SUMMARY OF THE INVENTION

The present disclosure relates to a multi-panel structure designed to attenuate sound transmission. In an embodiment, the structure consists of a plurality of panels and absorbers arranged in an alternating manner. Each absorber is fully enclosed between two consecutive panels, ensuring effective sound blocking. The panels are made of continuous and uninterrupted materials with substantially homogeneous physical properties, while at least one panel incorporates a meta-material having a metallic substance and a matrix substance. The metallic substance occupies at least 5% volume and the matrix substance occupies at least 10% volume of the meta-material. The metallic substance is arranged in no particular arrangement, and the spatial positioning of the metallic substance in the matrix substance is not predetermined. Additionally, the absorbers' comprise porous materials consisting of solid and fluid parts. In some embodiments, the at least one of the absorbers' porous material is a meta-material consisting of solid and fluid parts.

The panels, in the embodiments of the present disclosure, have certain characteristics to optimize sound attenuation. They may have an average bulk density ranging from about 0.5 gram per cubic centimeter to about 8 grams per cubic centimeter, an average elastic modulus ranging from about 1 gigapascal to about 200 gigapascal, and an average damping ratio ranging from about 0.05 to about 0.25. These properties contribute to the structure's sound-blocking effectiveness.

In some embodiments, the absorbers, which alternate between panels, feature meta-materials that aid in sound absorption. Generally, with or without meta-materials, the absorbers possess an average bulk density ranging from about 0.01 gram per cubic centimeter to about 1 gram per cubic centimeter, and a solid volume fraction ranging between about 0.01 and about 0.9. The absorbers consist of a solid part and a fluid part, with the solid part having an average elastic modulus ranging from about 1 gigapascal to about 200 gigapascal and an average Poisson's ratio ranging from about 0.25 to about 0.49.

The combined thickness of the multi-panel structure is limited to approximately 250 mm, ensuring a compact design suitable for various applications.

Furthermore, specific embodiments of the present disclosure are described. In one embodiment, the meta-material of the absorbers incorporates a metallic substance, occupying at least 1% of the volume of the meta-material. The metallic substance is arranged in no particular arrangement, and the spatial positioning of the metallic substance in the meta-material is not predetermined. Another embodiment involves a structure comprising three panels and two absorbers, with each absorber enclosed between two panels. In some embodiments, the metallic substance in the panels' meta-material may include iron, steel, copper, aluminum, and other metals, as well as their alloys. The meta-materials of some embodiments can have a metallic substance in various forms, such as fibers, filaments, nonwoven or woven fabrics, foams, granules, powders, and more. Meanwhile, the matrix substance of the meta-material of the present disclosure may broadly consist of glass, metal oxides, silica, gypsum, ceramics, wood, cellulose, thermoplastic or thermoset polymers, and their blends and combinations.

Recycled materials can be employed as the metallic substance or matrix substance of the meta-material in some embodiments. This allows for eco-friendly construction without compromising the structure's sound-blocking capabilities.

In a specific embodiment involving three panels and two absorbers, the second and third panels contain a meta-material comprising an iron alloy occupying at least 85% of the volume, while the matrix substance is polyvinyl chloride occupying at least 10% of the volume. These panels have an average bulk density ranging from about 6.8 grams per cubic centimeter to about 7.2 grams per cubic centimeter, an average elastic modulus ranging from about 170 gigapascal to about 190 gigapascal, and an average damping ratio ranging from about 0.05 to about 0.15. The combined thickness of this embodiment is less than about 240 mm.

The general scope of the present disclosure further comprises a computer-implemented method for designing a multi-panel structure to attenuate sound transmission using a stack of models. The method involves the use of four artificial intelligence models, each serving a specific purpose in the design process. These models are the first artificial intelligence model, the second artificial intelligence model, the third machine learning optimization model, and the fourth generative artificial intelligence model.

The first artificial intelligence model receives a training dataset containing material properties and corresponding sound transmission loss values for a plurality of multi-panel structures. This model applies an artificial intelligence algorithm to create a trained model capable of predicting sound transmission loss values at different frequencies for new multi-panel structures based on their material properties.

The second artificial intelligence model receives a training dataset containing material properties and corresponding sound transmission loss values for a plurality of multi-panel structures. It preprocesses the dataset using the most important material properties identified by the first artificial intelligence model. The preprocessing further comprises weighting and aggregating the sound transmission loss values to generate weighted sound transmission ratings, and normalizing the weighted sound transmission ratings by total basis weight of multi-panel structures to create normalized sound transmission ratings as the target values. This second artificial intelligence model then generates a second trained model capable of predicting normalized sound transmission ratings for new multi-panel structures.

The third machine learning optimization model receives the processed dataset from the second artificial intelligence model and applies an optimization algorithm within specified constraints to maximize the sound transmission ratings for the multi-panel structures. This model provides optimized material properties and their corresponding sound transmission ratings.

The fourth generative artificial intelligence model receives constraints from the third machine learning optimization model and generates a set of optimized material properties in the neighborhood of the previously obtained optimized properties. It calculates occurrence probability values for these generated properties and their corresponding sound transmission ratings.

In a preferred embodiment, the training datasets consist of material properties such as thickness, bulk density, elastic modulus, damping ratio, Poisson's ratio, air flow resistivity, and porosity of the multi-panel structures. In an embodiment, the preprocessing of datasets includes feature engineering algorithms such as transformer models, large language models, auto-encoders, generative adversarial networks, diffusion models, convolutional neural networks, target encoders, principal component analysis, singular vector decomposition, wavelet transforms, Fourier descriptors, clustering, and combinations thereof.

Additionally, in some embodiments, the first and second artificial intelligence algorithms involve selecting regression algorithms from a group including generalized linear regression, polynomial regression, support vector regression, decision tree regression, random forest regression, gradient boosting regression, extreme gradient boosting regression, light gradient boosting machine regression, neural network regression, graph neural network regression, transformer regression, foundational models, and combinations thereof. Hyperparameters of the selected algorithms are configured to create the respective trained model objects. In some embodiments, the preprocessing of the second training dataset comprises weighting of the sound transmission loss values against a reference spectrum values and human auditory response.

Embodiments also encompass a computer program product and a system, which comprises a processor, a memory, and access to a data storage unit for reading and writing datasets, for executing the computer-implemented method described above.

Furthermore, the present disclosure includes a computer simulation method to create a multi-panel structure for attenuating transmitted sound. This method utilizes the computer-implemented method mentioned earlier and involves generating internal structures and compositions of the multi-panel structure using input datasets. Sound transmission loss values of the multi-panel structure at various frequencies are calculated using methods such as finite element analysis, transfer matrix method, statistical energy analysis, plane wave models, and the first and second artificial intelligence models. The method outputs internal structures, compositions, and sound transmission loss values for the multi-panel structure.

Overall, the multi-panel structure the present disclosure for attenuating transmitted sound broadly provides an innovative and effective solution for soundproofing applications in various industries. And the computer-implemented method and the computer simulation method in this invention broadly provide an efficient and accurate way to design multi-panel structures for attenuating sound transmission, incorporating various material properties and optimizing the structure's acoustic performance.

### BRIEF DESCRIPTION OF THE FIGURES

FIG. 1A is a schematic diagram illustrating a multi-panel structure, according to some embodiments of the present disclosure.

FIG. 1B is a cross-sectional view L-L′ of the multi-panel structure referenced in FIG. 1A, according to some embodiments of the present disclosure.

FIG. 2A is a schematic diagram illustrating a three-panel structure, according to some embodiments of the present disclosure.

FIG. 2B is a cross-sectional view M-M′ of the three-panel structure referenced in FIG. 2A, according to some embodiments of the present disclosure.

FIG. 3 is a plot showing a comparison of average values of sound transmission loss values of embodiments of the present disclosure relative to those of standard building materials.

FIG. 4A is a plot showing sound transmission loss values for the multi-panel structures, according to some embodiments of the present disclosure.

FIG. 4B is a plot showing sound transmission loss values for the multi-panel structures utilizing standard building materials.

FIG. 5 is a plot showing a comparison of sound transmission loss values of embodiments of the present disclosure relative to those of standard building materials.

FIG. 6 is a block diagram further illustrating the multi-panel structure, according to some embodiments of the present disclosure.

FIG. 7A is a flowchart illustrating a computer-implemented method for designing a multi-panel structure, according to some embodiments of the present disclosure.

FIG. 7B is a flowchart extending from FIG. 7A and further illustrating the computer-implemented method for designing a multi-panel structure, according to some embodiments of the present disclosure.

FIG. 7C is a flowchart extending from FIG. 7B and further illustrating the computer-implemented method for designing a multi-panel structure from FIG. 7A, according to some embodiments of the present disclosure.

FIG. 8 is a flowchart further illustrating the computer simulation method for designing a multi-panel structure from FIG. 7A, according to some embodiments of the present disclosure.

### DETAILED DESCRIPTION

### Definitions

“Meta-material”, as used herein, refers to an engineered material that exhibits unique properties not found in naturally occurring substances. It is designed to manipulate and control the propagation of sound waves through the material. The meta-material may comprise various structures or elements arranged in a particular pattern or configuration to achieve desired acoustic characteristics. These characteristics may include sound absorption, sound reflection, or sound transmission control. The meta-material of the present disclosure may be broadly tailored to exhibit properties not typically observed in traditional materials, allowing for enhanced sound attenuation and improved noise blocking performance.

“Basis weight”, as used herein, also referred to as “surface mass”, is a measurement of the mass per unit area of a material. It quantifies the weight of a specific material per unit area, typically expressed in kilograms per square meter (kg/m²) or pounds per square yard (lb/yd²). It provides an indication of the material's weight distribution across a given area, which is relevant for assessing its mechanical, physical, or acoustical properties.

“Storage modulus”, as used herein, means a fundamental property of materials that represents their ability to store elastic energy when subjected to an applied stress or strain. It quantifies the stiffness or rigidity of a material and measures the material's resistance to deformation. The storage modulus is a real component of the complex modulus, which describes the material's response to oscillatory forces or deformations. A higher storage modulus indicates a stiffer material with greater elastic behavior and less energy dissipation.

“Loss modulus”, as used herein, means a fundamental property of materials that represents their ability to dissipate energy as heat when subjected to an applied stress or strain. It quantifies the material's internal friction or energy dissipation capacity. The loss modulus is the imaginary component of the complex modulus and describes the material's response to oscillatory forces or deformations. A higher loss modulus indicates a material with greater energy dissipation and less elastic behavior, leading to increased damping and reduced vibration transmission.

“Damping ratio”, as used herein, means ratio of the loss modulus to the storage modulus of the material. High damping ratio signifies higher damping and reduced vibration transmission.

“Matrix”, as used herein, refers to the main or continuous material that forms the bulk or structure of a meta-material. In the broad context of the present disclosure, the matrix substance is the primary constituent of the meta-material used in the panels or absorbers. It provides the structural integrity and support to the meta-material and may consist of various materials, such as glass, metal oxides, silica, gypsum, ceramics, wood, cellulose, thermoplastic or thermoset polymers, or their blends and combinations. The matrix substance surrounds or encompasses other components, such as metallic substances or additives, within the meta-material, contributing to the overall performance of the multi-panel structure.

“Hyperparameters”, as used herein, are the adjustable parameters or settings that are predefined and set by the user or model designer before the training process begins in machine learning and artificial intelligence algorithms. These parameters control the behavior and performance of the learning algorithm during the training phase. Hyperparameters are distinct from model parameters, which are learned from the training data. Examples of hyperparameters include the learning rate, regularization strength, number of layers or nodes in a neural network, kernel size in convolutional neural networks, or the depth of decision trees. Optimizing hyperparameters is crucial for achieving the desired performance and generalization of the model.

“One-third octave frequencies”, as used herein, refer to a series of discrete frequency bands used for analyzing and characterizing acoustic signals or sound spectra. Each one-third octave band covers a specific frequency range and is one-third the width of the adjacent octave band. The division of the frequency range into one-third octave bands allows for a more detailed representation of the distribution of sound energy across different frequencies. In a one-third octave frequency analysis, the entire audible frequency range is divided into multiple bands, typically starting from approximately 20 Hz (lower limit of human hearing) to around 20,000 Hz (upper limit of human hearing). The boundaries of each one-third octave band are logarithmically spaced to ensure equal intervals on a logarithmic frequency scale. Each one-third octave band covers a specific frequency range, and the center frequencies of these bands are based on the one-third power of two (cube root of 2, approximately 1.2599) scale. The one-third octave bands are logarithmically spaced, and their center frequencies typically start from approximately 20 Hz and increase in a geometric progression with a factor of one-third power of two to cover the entire audible frequency range. The center frequencies of one-third octave bands are as follows: 20, 25, 31.5, 40, 50, 62.5, 80, 100, 125, 160, 200, 250, 320, 400, 500, 630, 800, 1000, 1250, 1600, 2000, 2500, 3150, 4000, 5000, 6300, 8000, 10000, 12500, 16000, and 20000 Hz.

“Sound transmission rating”, as used herein, refers to a numerical measure used to quantify the sound insulation performance of a material or structure against airborne sound transmission. It indicates the material's ability to block sound and reduce its transmission from one side of the material to the other. The sound transmission rating is expressed in decibels (dB) and represents the difference in sound level between the source side (the side with the sound) and the receiving side (the side protected from the sound). A higher sound transmission rating indicates better sound insulation, meaning the material is more effective at blocking sound. There are different types of sound transmission ratings used to evaluate the sound insulation performance of materials and structures. Some of the common types include: (a) Sound Transmission Class (STC), which measures the material's ability to block sound across a range of frequencies, typically from 125 Hz to 4,000 Hz; (b) Impact Insulation Class (IIC), which measures the sound insulation of floors and floor-ceiling assemblies against impact noises, such as footfalls or dropped objects; (c) Outdoor-Indoor Transmission Class (OITC), which measures the ability of the fenestration to block sound transmission from the outdoor environment, such as exterior noises, to the interior space; and (d) Apparent Sound Transmission Class (ASTC), which is a rating that considers both airborne and impact sound transmission through walls and floor-ceiling assemblies. It combines the STC and IIC ratings to provide a comprehensive assessment of sound insulation performance.

“Machine learning optimization model”, as used herein, refers to a type of model that combines machine-learning techniques with optimization methods to find the optimal solution for a given objective or task. These models aim to optimize parameters or decisions within specified constraints, leveraging both machine learning algorithms and optimization techniques. Machine learning optimization models encompass a broad range of algorithms and methods, including non-linear optimization and linear programming. Non-limiting examples of algorithms commonly used in machine learning optimization models include gradient descent, evolutionary algorithms, genetic programming, particle swarm optimization, simulated annealing, Bayesian optimization, Newton's method, conjugate gradient, Nelder-Mead algorithm, linear programming, and combinations thereof.

“Generative artificial intelligence (AI) model”, as used herein, refers to a type of AI model that is designed to generate new and original content based on patterns and examples it has learned from a given dataset. These models possess the ability to autonomously create outputs that resemble the training data, within the provided constraints and exhibiting creativity and diversity. Generative AI models can employ a variety of algorithms, including both deep learning and traditional machine learning (ML) algorithms, to achieve their objective. The choice of algorithm may depend on factors such as the nature of the dataset, the desired output format, and the specific requirements or constraints of the application. Non-limiting list of algorithms commonly used in generative AI models include transformers, state-space models, diffusion models, variational auto-encoders, generative adversarial networks, recurrent neural networks, Metropolis-Hastings algorithm, simulated annealing, genetic algorithms, reinforcement learning, and combinations thereof. These examples demonstrate the range of algorithms that can be utilized in generative AI models, encompassing both deep learning and traditional ML approaches. It is important to note that the specific choice of algorithm may vary based on the application, dataset, and desired output format.

The multi-panel structure for attenuating the transmission of incident sound provides an effective solution for sound attenuation in various applications. By utilizing panels and absorbers with meta-materials, the structure achieves improved sound attenuation capabilities. The detailed description and embodiments provided herein serve to illustrate the various aspects and features of the present disclosure in a broad sense, but they are not intended to limit the scope of the claims.

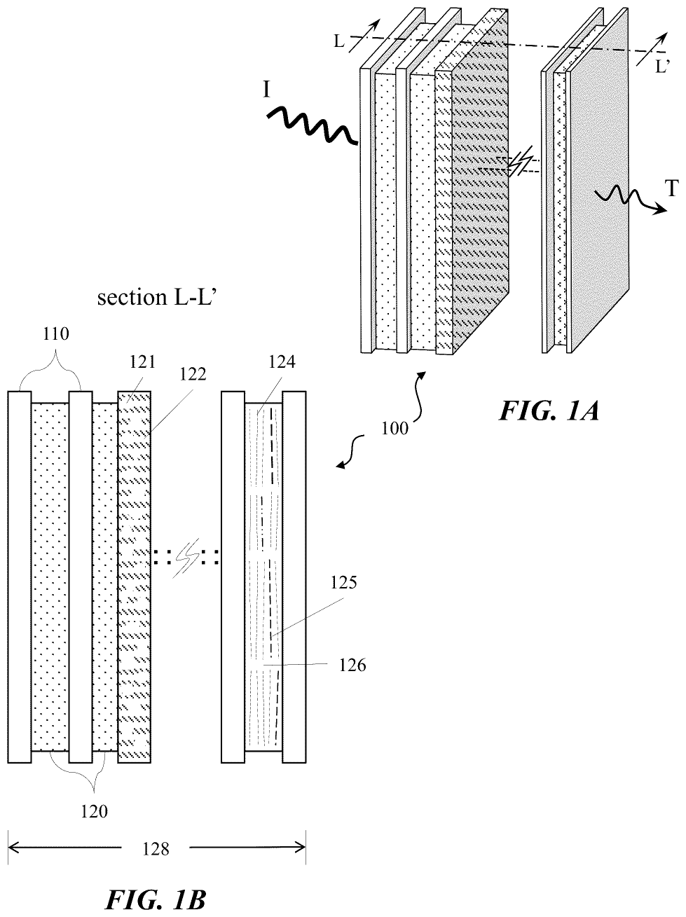

FIG. 1A and FIG. 1B, respectively, illustrate a perspective view and a cross-sectional view L-L′ of a multi-panel structure 100 comprising a plurality of panels 110. The individual panels 110 are arranged in a sequential order and are separated by absorbers 120. The absorbers 120 are fully enclosed between the panels 110, consecutive to one another, such that the absorbers 120 alternate between individual panels 110. At least one of the panels comprises a meta-material 121, which comprises a metallic substance 122 embedded in a matrix substance. The absorbers 120 comprise a porous material consisting of a solid part 125 and a fluid part 126. In some embodiments, the porous material of at least of the absorbers is a meta-material 124, which comprises a metallic substance. Thickness 128 is the combined thickness of the multi-panel structure. An incident sound “I” falls on the left-most panel and a transmitted sound “T” leaves the right-most panel.

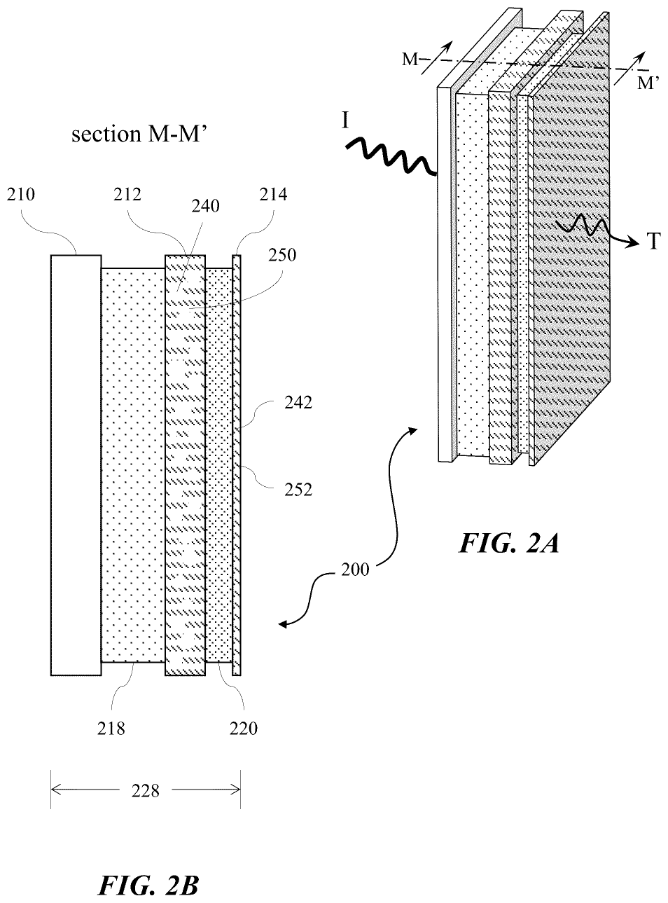

FIG. 2A and FIG. 2B, respectively, illustrate a perspective view and a cross-sectional view M-M′ of an embodiment of a multi-panel structure 200 comprising three panels, namely a first panel 210, a second panel 212, and a third panel 214. The panels are arranged in a sequential order and are separated by absorbers. In this embodiment, two absorbers are utilized, namely a first absorber 218 and a second absorber 220. The first absorber 218 is fully enclosed between the first panel 210 and the second panel 212, while the second absorber 220 is fully enclosed between the second panel 212 and the third panel 214. In a specific embodiment, the second panel 212 and the third panel 214 may further comprise meta-materials 240 and 242, respectively. The meta-materials 240 and 242 may comprise metallic substances 250 and 252, respectively. Thickness 228 is the combined thickness of the multi-panel structure. An incident sound “I” falls on the first panel 210 and a transmitted sound “T” leaves the third panel 214.

The panels in above embodiments are formed from substantially continuous and uninterrupted materials without any holes, perforations, pockets, or cellular structures. The physical properties, such as mass, bulk density, elastic modulus, Poisson's ratio, damping ratio, and such are substantially homogeneous at the incident sound wavelength size scale. The substantial homogeneity at the incident sound wavelength size scale can be explained using a non-limiting example as follows. Consider an 8,000 Hz frequency sound incident upon an embodiment's panel of thickness “t” in about 20 degrees Celsius air environment. At this temperature, the speed of sound in air is about 343 m/s. Therefore, the sound wavelength (=speed of sound divided by frequency) would be about 43 mm corresponding to about 8,000 Hz frequency sound. From the panel, if a plurality of square samples, with side length of about 43 mm and thickness “t”, are taken and their physical properties measured, then the physical properties across all the samples will be substantially homogeneous. Numerically, the substantial homogeneity may be defined by coefficient of variation (standard deviation divided by the mean) of a physical property. For a substantially homogeneous panel of an embodiment, a physical property's coefficient of variation would be less than 30%, more preferably less than 20%, and most preferably less than 10%.

At least one of the panels of the embodiments comprises a meta-material, wherein a metallic substance and a matrix substance are combined. The metallic substance occupies at least 5% volume of the meta-material, and the matrix substance occupies at least 10% volume of the meta-material. In a preferred embodiment, the metallic substance occupies at least 25% volume of the meta-material. In a more preferred embodiment, the metallic substance occupies at least 50% volume of the meta-material. In some embodiments, the metallic substance may even occupy at least 75% volume of the meta-material. In general, the embodiments may have the metallic substance occupying from about 5% to about 90% of the volume of the meta-material. The metallic substance is generally embedded in the matrix substance.

The metallic substance is arranged in no particular arrangement when embedded in the matrix substance. The spatial positioning of the metallic substance in the matrix substance is not predetermined. In some embodiments, the metallic substance is statistically randomly distributed in the matrix substance. Some embodiments may have the metallic substance oriented in one or many random directions while spatially randomly distributed. However, the spatial positioning of the metallic substance is neither predetermined nor fixed. In all embodiments, the metallic substance arrangement and spatial positioning is such that the physical properties of the panel are substantially homogeneous at the incident sound wavelength size scale.

The absorbers also utilize meta-materials for sound attenuation purposes. In some embodiments, the porous material of at least one of the absorbers is a meta-material. The meta-material of the absorbers consists of a solid part and a fluid part. The solid part comprises a metallic substance, similar to the panels. The metallic substance occupies at least 1% of the volume of the meta-material. In a preferred embodiment, the metallic substance occupies at least 2% volume of the meta-material. In a more preferred embodiment, the metallic substance occupies at least 5% volume of the meta-material. The metallic substance is arranged in no particular arrangement in the meta-material of the absorbers. The spatial positioning of the metallic substance is not predetermined in the absorbers' meta-material. In some embodiments, the metallic substance is statistically randomly distributed in the absorbers' meta-material. Some embodiments may have the metallic substance oriented in one or many directions while spatially randomly distributed. However, the spatial positioning of the metallic substance is neither predetermined nor fixed.

The meta-material may comprise various metallic substances. In some embodiments the metallic substance is selected from a group consisting of iron, steel, copper, aluminum, nickel, molybdenum, chromium, zinc, magnesium, manganese, tin, gold, silver, platinum, titanium, and alloys and mixtures thereof. In a preferred embodiment, the metallic substance comprises an iron alloy. Non-limiting examples of iron alloys include carbon steel, stainless steel, gray iron, ductile iron, cast iron, pig iron, Wrought iron, chromoly, and combinations thereof. In another preferred embodiment, the metallic substance comprises a copper alloy. Non-limiting examples of copper alloys include brass, bronze, phosphor bronze, aluminum bronze, silicon bronze, cupronickel, and combinations thereof. In yet another embodiment, the metallic substance comprises an aluminum alloy.

The metallic substance can be in the form of bars, rods, plates, wires, cables, fibers, filaments, ribbons, nonwoven or woven fabrics, foams, strands, chips, turnings, fillings, shavings, granules, powders, or combinations thereof. Non-limiting examples of forms of fibrous metallic substance include metal wools, netting, weaves, knits, and combinations thereof.

The matrix substance in the meta-material can be selected from a wide range of materials. In some embodiments, the matrix substance of the meta-material is selected from a group consisting of glass, metal oxides, silica, gypsum, Portland cement, ceramics, wood, cellulose, sand, clay, wool, thermoplastic polymer, thermoset polymer, cross-linked polymer, and combinations thereof. Thermoplastic polymers such as polyvinyl chloride, polyolefins, thermoplastic polyurethanes, polyethylene terephthalate, aliphatic polyesters, polyamides, polystyrenes, and their blends, copolymers, and combinations can be utilized in some embodiments. Similarly, thermoset polymers such as vulcanized rubber, bakelite, duroplast, phenol-formaldehyde resins, urea-formaldehyde resins, melamine-formaldehyde resins, epoxy resins, polyimides, silicone resins, cyanate esters, polyurethane resins, furan resins, vinyl ester resins, polyester resins, benzoxazines, and their blends, copolymers, and combinations can be employed in some embodiments.

The metallic substance of the meta-material can be a recycled material, contributing to sustainability and environmental considerations. Similarly, the matrix substance of the meta-material can also be a recycled material, further enhancing the eco-friendliness of the multi-panel structure. The recycled metallic substances may comprise scraps from many industries, including but not limited to machining, electronics, demolition, and construction industries. Similarly, recycled matrix substances may comprise scraps from industries, including but not limited to timber, construction, and demolition industries.

The composition of the panel and the absorber materials is selected to optimize their physical properties that maximize the sound transmission loss across a wide-range of incident sound wave frequencies. Each panel has an average bulk density ranging between about 0.5 gram per cubic centimeter to about 8 grams per cubic centimeter, an average elastic modulus ranging between about 1 gigapascal to about 200 gigapascal, and an average damping ratio ranging between about 0.01 to about 0.25. In a preferred embodiment, each panel has an average bulk density ranging between about 1 grams per cubic centimeter to about 7.5 grams per cubic centimeter, an average elastic modulus ranging between about 10 gigapascal to about 200 gigapascal, and an average damping ratio ranging between about 0.05 to about 0.2. In a more preferred embodiment, each panel has an average bulk density ranging between about 1.5 grams per cubic centimeter to about 7.5 grams per cubic centimeter, an average elastic modulus ranging between about 20 gigapascal to about 200 gigapascal, and an average damping ratio ranging between about 0.05 to about 0.15.

Each absorber has an average bulk density ranging between about 0.01 gram per cubic centimeter to about 1 gram per cubic centimeter, a solid volume fraction ranging between about 0.01 and about 0.9, an average elastic modulus of the solid part ranging between about 1 gigapascal to about 200 gigapascal, and an average Poisson's ratio of the solid part ranging between about 0.25 and about 0.49. In preferred embodiments, each of the absorbers has an average bulk density ranging between about 0.01 gram per cubic centimeter to about 0.8 gram per cubic centimeter, a solid volume fraction ranging between about 0.01 and about 0.5, an average elastic modulus of the solid part ranging between about 10 gigapascal to about 100 gigapascal, and an average Poisson's ratio of the solid part ranging between about 0.3 and about 0.49. In the most preferred embodiments, each of the absorbers has an average bulk density ranging between about 0.01 gram per cubic centimeter to about 0.6 gram per cubic centimeter, a solid volume fraction ranging between about 0.01 and about 0.5, an average elastic modulus of the solid part ranging between about 10 gigapascal to about 75 gigapascal, and an average Poisson's ratio of the solid part ranging between about 0.3 and about 0.49.

The combined thickness of the multi-panel structure is less than or equal to about 250 mm, ensuring that the structure can be conveniently incorporated into various applications without excessive size constraints. In a preferred embodiment, the combined thickness of the multi-panel structure is less than or equal to about 240 mm. In a more preferred embodiment, the combined thickness of the multi-panel structure is less than or equal to about 200 mm.

In one embodiment, the multi-panel structure consists of three panels and two absorbers. The three panels are designated as a first panel, a second panel, and a third panel. The two absorbers are designated as a first absorber and a second absorber. The first absorber is fully enclosed between the first panel and the second panel, while the second absorber is fully enclosed between the second panel and the third panel. This specific configuration allows for effective sound attenuation through the sequential arrangement of panels and absorbers. In a specific embodiment of the above embodiment consisting of three panels and two absorbers, the second and the third panel comprise meta-materials. The metallic substance of the meta-material of the second and the third panels is an iron alloy, occupying at least about 85% of the volume of the meta-material. The matrix substance in the second and the third panels is polyvinyl chloride, occupying at least about 10% of the volume of the meta-material. The second panel and the third panel in this embodiment exhibit an average bulk density ranging between about 6.8 grams per cubic centimeter to about 7.2 grams per cubic centimeter, an average elastic modulus ranging between about 170 gigapascal to about 190 gigapascal, and an average damping ratio ranging between about 0.05 to about 0.15. The combined thickness of the multi-panel structure in this embodiment is less than about 240 mm.

Without being limited by any one theory, it is believed that the multi-panel structure of the present disclosure most likely utilizes sound reflection and absorption phenomena to attenuate the transmitted sound. It is believed that the panels' stiffness likely aids in reflecting the incident sound, while inertial damping and vibration damping in both the panels and the absorbers may be driving the absorption phenomenon. The meta-materials in the embodiments most likely attenuate sound by all three mechanisms: sound reflection, inertial damping, and vibrational damping. It is believed that the high stiffness and high bulk density of the metallic substance in the panels' meta-materials assist in sound reflection and inertial damping, respectively, while the matrix substance most likely aids in vibrational damping through viscous dissipation. Meanwhile, the porous structure of the absorbers most likely assists in vibrational damping through viscous and thermal dissipation. However, embodiments increase sound attenuation the absorbers by having stiff and dense solid members or walls in the porous absorbers. It is anticipated that the metallic substance in the absorbers' meta-materials increases reflections and inertial damping inside the absorbers owing to its high stiffness and high bulk density, respectively. Because the metallic substance is arranged in no particular arrangement in the matrix substance, and may even be statistically randomly distributed in the matrix substance, a wide-range of sound frequencies with a wide-range of incidence angles are expected to have more or less an equal chance of getting attenuated by the embodiments. It is believed that no particular sound wavelength or no particular incidence angle has a preferential attenuation when the sound is incident upon the embodiments.

Without being bound by any one theory, it is additionally believed that sound transmission amplifies when an individual panel resonates at its fundamental frequency or in the coincident frequency range (when the sound wavelength in air is equal to the wavelength of bending waves in the panel). Furthermore, it is believed that the sound transmission increases in a multi-panel structure when air mass between the panels resonates or there is a standing wave resonance between the panels. However, the embodiments are believed to minimize the excessive sound transmission at various resonant and coincident frequencies associated with the multi-panel structure. By combining panels of different physical properties, such as bulk density, thickness, elastic modulus, and Poisson's ratio, the panels of embodiments are believed to have different resonance and coincident frequency profiles, which allow for compensating increased transmission of any one panel at its resonant or coincident frequency range. Similarly, by having absorbers of different physical properties, such as thickness, bulk density, porosity, elastic modulus, and Poisson's ratio, the embodiments are believed to minimize the transmission amplification effects of air mass resonance and the standing wave resonance.

The panels in the embodiments that do not comprise meta-materials may be selected from commonly used building materials. Non-limiting examples of the commonly used building materials include clay bricks, concrete, stucco, ceramic tiles, porcelain tiles, alumina tiles, gypsum, plywood, chipboard, medium density board, particle board, oriented strand board, laminated veneer lumber, wood-plastic composites, wood, metal sheets, metal tiles, polymer siding, glass panes, polymer panes, and combinations thereof. Similarly, the absorbers in the embodiments that do not comprise meta-materials may be selected from commonly used insulation and absorbing materials in building constructions. Non-limiting examples of the commonly used insulation and absorbing materials include glass wool, mineral wool, polymeric foams, resin foams, cellulosic foams, metal foams, wood fibers, cellulosic fibers, polymeric fibers and filaments, feather or light density boards, corkboards, and combinations thereof.

### Methods of Making the Meta-Materials of the Panels

The meta-materials used in the panels of the present disclosure, in a large sense, may be manufactured by modifying the existing methods to make reinforced composites. Because the meta-materials of the panels comprise the metallic substance in high concentration (at least 5% by volume), additional care may be needed to manage higher concentration of metallic substances in the process. While high fiber volume composites are widely used in aircraft structures, automotive components, wind turbine blades, sporting goods, boat hulls, defense applications, construction elements, and oil and gas infrastructure, the methods for making the meta-materials would need additional modifications to the existing processes.

For some embodiments, in which the metallic substance is in the form of fibers, filaments, ribbons, nonwoven or woven fabrics, foams, wires, cables, or even strands, and the matrix substance is any of thermoplastic polymer, thermoset polymer, or cross-linked polymer, then the existing resin-based reinforced composite making processes may be modified for making the meta-materials of the embodiments. Non-limiting examples of making fiber-reinforced composites comprising polymer or resin matrix include prepreg layup, resin transfer molding, vacuum assisted resin infusion, filament winding, automated fiber placement, and combinations thereof. An ordinarily skilled in the art of polymeric composites would be able to employ these processes and ensure a high fiber content in the final composite by carefully arranging fibers and impregnating them with resin, either through stacking prepreg sheets, injecting resin under pressure, infusing resin under vacuum, winding fibers onto a mandrel, pulling fibers through a heated die, or using robotic systems for controlled fiber placement. The selection of a particular process or a combination of processes would depend on the metallic substance's form, desired properties, complexity, yield required, and cost.

When the metallic substance of the meta-material is in the form of chips, turnings, fillings, shavings, granules, powders, it can be mixed homogeneously with the matrix and then molded or cast into the desired shape of the panel. However, the metallic substance in such embodiments may need to be pre-processed before mixing with the matrix. Non-limiting methods of pre-processing the metallic substance in the form of chips, turnings, fillings, shavings, granules, powders may include cleaning, sorting, chopping, cutting, grinding, and combinations thereof. The metallic substance of the meta-materials in the form of bars, rods, plates, or cables may need to be pre-processed and carefully placed in the matrix manually or using automated means before be molded or cast into the desired shape for the panels of the embodiments.

For embodiments, in which the matrix substance is glass, the meta-materials of the panels may be manufactured by adding the metallic substance to the molten glass mixture with other additives for better binding and homogenization. The molten glass with the added metallic substance can be thoroughly mixed to ensure homogeneity and uniform distribution of the additives throughout the glass-metal composition. Once the molten glass-metal composition is properly mixed, it can be formed into panels using various techniques. Non-limiting methods include float glass production, where the molten glass-metal composition can be poured onto a bath of molten metal (for example, tin), or glass sheet rolling, where the molten glass-metal composition can be poured onto rollers and then flattened and cooled. After the glass-metal meta-material panels are formed, they can undergo an annealing process to relieve internal stresses and improve their strength and durability. The meta-material panels can be slowly cooled in a controlled manner to avoid thermal shock and ensure proper crystalline structure development. The glass meta-material panels may undergo additional processes such as cutting, grinding, polishing, or coating to achieve the desired final product specifications and appearance. In a broad sense, for the embodiments of the present disclosure, specific techniques, temperatures, and additives used can be varied depending on the desired meta-material composition and the manufacturing process employed.

For embodiments, in which matrix substance is selected from a group consisting of metal oxides, silica, gypsum, Portland cement, ceramics, sand, clay and combinations thereof, the meta-materials of the panels may be manufactured by adding metallic substance to the slurry of matrix along with any other additives to provide better adhesion, strength, or finish. The mixture can then be poured into molds or cast, statically or onto a moving conveyor belt. The molds or belt can have various dimensions and shapes to achieve the desired meta-material specifications. The mixture-filled molds or belt can be compacted or pressed to remove excess water and ensure uniform distribution of the matrix and metallic substances mixture. This step can help in achieving the desired bulk density and structural integrity of the meta-material. The molded meta-material can be cured and dried to harden the matrix and remove any remaining moisture. Curing and drying can be done at room temperature or using controlled drying chambers. Once the meta-material is fully cured and dried, it can trimmed to the desired dimensions and undergo any necessary finishing processes. This may include sanding, painting, or applying other surface treatments to achieve the desired appearance and texture.

For embodiments, in which matrix substance is selected from a group consisting of wood, cellulose, wool, and combinations thereof, the meta-materials of the panels may be manufactured by combining metallic substance with the mixture of the matrix substance, binders, and other processing aids. Non-limiting examples of binders include resins, adhesives, and thermoset polymers, and thermoplastic polymers. The matrix substance may be pre-processed before mixing with binders and processing aids. The wood particles should be desirably of consistent size and moisture content. Similarly, the metallic substances may be pre-processed before combining with the mixture of the matrix substance, binders, and any processing aids. The metallic substances, such as turnings, shavings, granules, strands, or wires, may be prepared separately. They may need to be cleaned, sorted, or processed to remove any contaminants or unwanted materials. The prepared matrix substance and metallic substance can be combined together in a mixing chamber. A resin binder, typically a urea-formaldehyde or melamine-urea-formaldehyde resin, can be added to the matrix and metallic substances mixture. The resin can act as a binder, providing cohesion and strength to the meta-material panel. The matrix and metallic substances mixture, along with the resin, can be thoroughly blended to ensure even distribution of the components. The blended mixture can then formed into a mat by spreading it onto a conveyor belt or forming line. The mat can be compressed under heat and pressure using a hot press to activate the resin, allowing it to cure and bond the matrix and the metallic substances together. After the desired compression and curing time, the meta-material panel can be cooled and trimmed to the desired dimensions. Surface treatments such as sanding or coating may be applied to achieve a smoother finish.

### Methods of Making the Meta-Materials of the Absorbers

The meta-materials used in the absorbers of the present disclosure, in a broad sense, may be manufactured by modifying the existing methods to make reinforced insulating materials. Because the meta-materials of the panels comprise the metallic substances, additional care may be needed to manage addition of metallic substances in the process. The metallic substances may be present with other materials in the solid part of the meta-materials of the embodiments. Non-limiting examples of other materials include glass wool, fiberglass, mineral wool, polymeric foams, resin foams, cellulosic foams, wood fibers, cellulosic fibers, polymeric fibers and filaments, feather or light density boards, corkboards, and combinations thereof.

One of the manufacturing methods for producing the meta-material of the embodiments involves the melting and blending of the metallic substances with the absorber material. In this method, the metallic substances are introduced into the molten state of the absorber material. The other absorber material, such as glass, rock, slag, or polymer, is heated to its melting point within a controlled environment. Concurrently, the metallic substances are introduced into the molten absorber material, ensuring thorough mixing and dispersion. The resulting molten mixture is then subjected to spinning processes to form meta-material's fibers or other suitable forms.

In an alternative process to incorporate metallic substance in the absorber's meta-material, a post-blending method may be used. The base absorber is produced without the metallic substances, utilizing established manufacturing methods for insulation materials. After the absorber is formed into its desired shape, a subsequent post-blending stage is introduced. Metallic substances are applied to the surface as coating or injected into the pre-formed meta-material. The meta-material with the added metallic substances is then subjected to controlled heating or curing processes to ensure proper bonding and integration, resulting in a final absorber meta-material with metallic substance. In some embodiments, the metallic substances may be co-formed with the other materials during spinning or other forming processes.

In some embodiments, where metallic substances are in the form of fibers, filaments, or wool, they can be pre-mixed with cellulosic, wood, or polymeric fibers. The resultant mixture can then be carded and formed into the meta-material of the absorber.

The metallic substances may be pre-processed before combining with the other materials of the absorber meta-material. The metallic substances, such as turnings, shavings, granules, strands, or wires, may be prepared separately. They may need to be cleaned, sorted, or processed to remove any contaminants or unwanted materials.

### Methods of Designing the Multi-Panel Structure

The multi-panel structure of the present disclosure, in a broad sense, may be designed by experimenting with the panels and absorbers of the embodiments. The experimentation process may involve physical experiments or computer-aided experiments or both. In general, the physical experimentation would comprise creating embodiments of multi-panel structure from the panels and the absorbers, followed by exposing the embodiments to a range of frequencies, preferably one-third octave frequencies ranging from 20 Hz to 20,000 Hz, at a pre-specified intensity level in decibels (dB), and then measuring the transmitted intensity level in decibels. The sound transmission loss would then be evaluated by subtracting the measured intensity level from the pre-specified intensity level, typically the incident sound intensity level. An ordinarily skilled in the art could iterate through a controlled design of experiments using conventional multi-panel structures to optimize for a desired sound transmission loss. However, the physical experimentation may be limited by availability or construction of the conventional multi-panel structures and/or time and other resources. Alternatively, computer-implemented methods using artificial intelligence models may be used independently or in combination with the physical experimentation to design the multi-panel structure embodiments, including the composition and structure of the comprising panels and absorbers, and their comprising meta-materials.

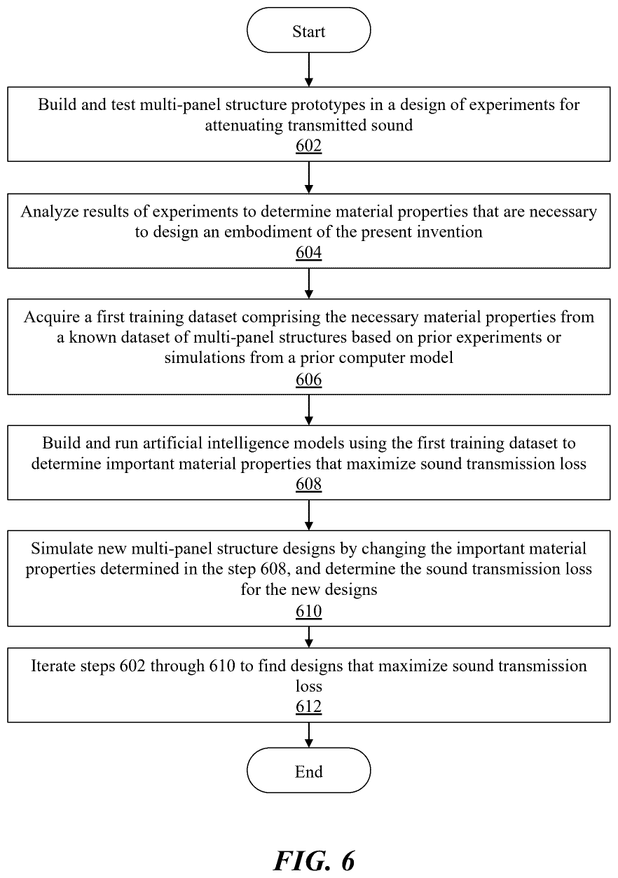

FIG. 6 is a flowchart that describes an optimization process that one could employ to create multi-panel structure embodiments related to attenuate transmitted sound. In step 602, conventional multi-panel structure prototypes may be built and tested in a design of experiments (DOE) setup to evaluate their effectiveness in attenuating transmitted sound. The results of these experiments may be analyzed in step 604 to identify the material properties that are crucial for designing an embodiment. In step 606, a first training dataset may be acquired, comprising the necessary material properties. This dataset may be obtained from a known dataset of the conventional multi-panel structures, which is based on prior experiments or simulations from a prior computer model. Moving on to step 608, artificial intelligence (AI) models may be constructed and executed using the first training dataset. The purpose would be to determine the significant material properties that contribute most to maximizing sound transmission loss in the multi-panel structures. In step 610, the AI models may be utilized to simulate new multi-panel structure designs. During this simulation, the important material properties identified in the previous step (608) may be modified to explore various design possibilities. The sound transmission loss for each of these new designs may be determined.

The optimization process may continue by iterating to find designs that effectively maximize sound transmission loss. Therefore, in step 612, the process may loop back to step 602 and iterate through the entire sequence of steps (602-610) until novel designs that significantly enhance sound transmission loss are identified. By following the process in this flowchart, one can systematically design multi-panel structures for attenuating transmitted sound by leveraging artificial intelligence and material property analysis techniques. This enables the creation of improved embodiments of the multi-panel structure that effectively minimize sound transmission in various applications. The present disclosure incorporates a computer-implemented method, similar to one described by steps (606-610), to design a multi-panel structure for attenuating transmitted sound. Further, a computer-simulation method, similar to one in step 610 is also disclosed.

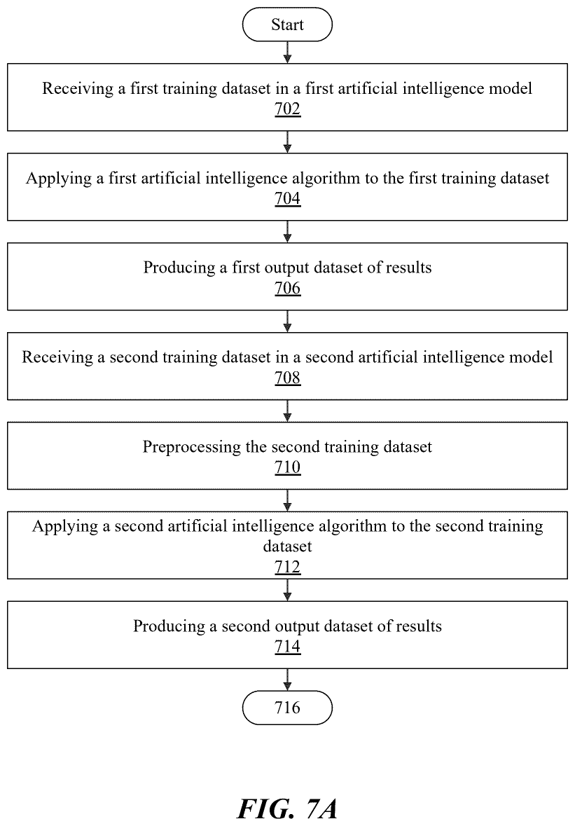

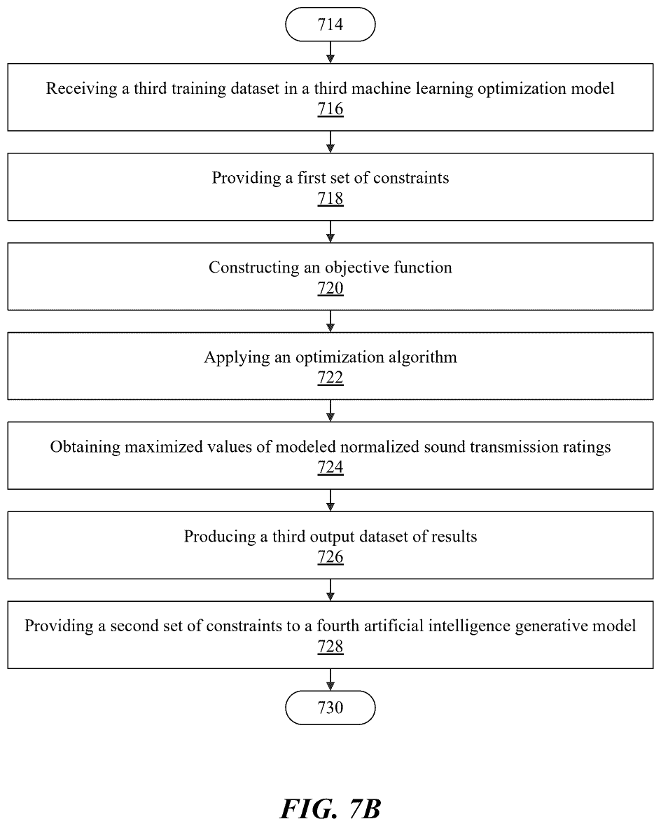

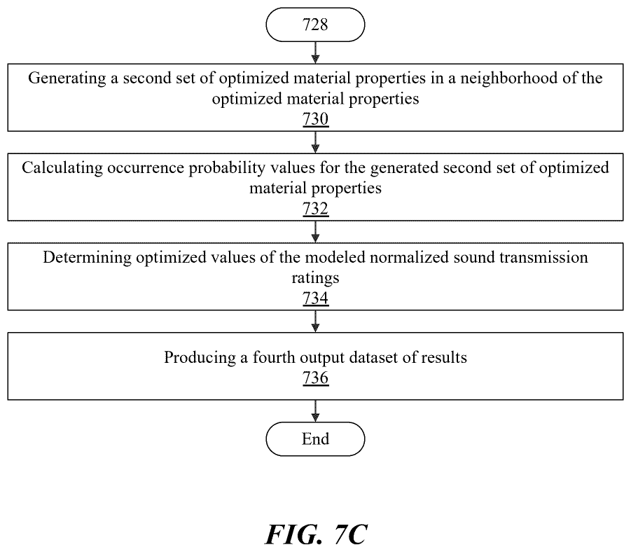

FIGS. 7A to 7C are flowcharts that describe a computer-implemented method enumerated in steps (606-610) of FIG. 6 for designing an embodiment of the multi-panel structure. The method utilizes a stack of models, which includes a first artificial intelligence model, a second artificial intelligence model, a third machine learning optimization model, and a fourth generative artificial intelligence model. In some embodiments, at step 702, the computer-implemented method may include receiving a first training dataset comprising a plurality of input features that comprise material properties of a plurality of multi-panel structures and a plurality of target values that comprise sound transmission loss values provided at a plurality of sound frequencies incident on the multi-panel structures. At 704, the computer-implemented method may include applying a first artificial intelligence algorithm to the first training dataset, and may comprise the steps of: (704-1) preprocessing the first training dataset into a processed first training dataset; (704-2) training the first artificial intelligence model using the processed first training dataset to create a first trained model object and predict modeled sound transmission loss values at a plurality of sound frequencies incident on the multi-panel structures; and (704-3) determining a relative importance of the material properties that explain predictability of the modeled sound transmission loss values from the first artificial intelligence model.

In some embodiments, at step 706, the computer-implemented method may include producing a first output dataset of results comprising the modeled sound transmission loss values and the relative importance of the material properties. At step 708, the computer-implemented method may include receiving the second training dataset comprising a plurality of input features that comprise material properties of a plurality of multi-panel structures and a plurality of target values that comprise sound transmission loss values at a plurality of sound frequencies incident on the multi-panel structures.

In some embodiments, at step 710, the computer-implemented method may include preprocessing the second training dataset into a processed second training dataset, comprising the steps of: (710-1) using a set of most important material properties from the first output dataset; (710-2) weighting and aggregating the sound transmission loss values to generate weighted sound transmission ratings; and (710-3) normalizing the weighted sound transmission ratings by total basis weight of multi-panel structures to create normalized sound transmission ratings as the target values. At step 712, the computer-implemented method may include applying a second artificial intelligence algorithm to the processed second training dataset, comprising the steps of: (712-1) training the second artificial intelligence model using the processed second training dataset to create a second trained model object and predict modeled normalized sound transmission ratings of the multi-panel structures; and (712-2) determining a relative importance of the material properties that explain predictability of the modeled normalized sound transmission ratings from the second artificial intelligence model. At step 714, the computer-implemented method may include producing a second output dataset of results comprising the modeled normalized sound transmission ratings of the multi-panel structures and the relative importance of the material properties.

In some embodiments, at step 716, the computer-implemented method may include receiving a third training dataset, comprising the processed second training dataset from the second artificial intelligence model. At step 718, the computer-implemented method may include providing a first set of constraints, comprising a plurality of constraints on the material properties of the third training dataset. At step 720, the computer-implemented method may include constructing an objective function, comprising the second trained model object and the first set of constraints.

In some embodiments, at step 722, the computer-implemented method may include applying an optimization algorithm to maximize the objective function within the first set of constraints by changing values of the material properties in the third training dataset. At step 724, the computer-implemented method may include obtaining maximized values of modeled normalized sound transmission ratings using the second trained model object and values of material properties utilized to maximize the objective function.

In some embodiments, at step 726, the computer-implemented method may include producing a third output dataset of results comprising the maximized values of the modeled normalized sound transmission ratings and corresponding optimized material properties. At step 728, the computer-implemented method may include providing a second set of constraints, comprising the constraints of the third machine learning optimization model and constraints defined by co-occurrence probabilities of material properties.

In some embodiments, at step 730, the computer-implemented method may include generating a second set of optimized material properties in a neighborhood of the optimized material properties from the third output dataset by applying an artificial intelligence algorithm on the optimized material properties from the third output dataset and utilizing the second set of constraints. At step 732, the computer-implemented method may include calculating occurrence probability values for the generated second set of optimized material properties relative to the processed second training dataset.

In some embodiments, at step 734, the computer-implemented method may include determining optimized values of the modeled normalized sound transmission ratings corresponding to the generated second set of optimized material properties using the second trained model object. At step 736, the computer-implemented method may include producing a fourth output dataset of results comprising the generated second set of optimized material properties and their corresponding occurrence probability values, and the optimized values of the modeled normalized sound transmission ratings.

The first and second artificial intelligence models may utilize respective first and second training datasets obtained from an external database or experimental measurements or even a computer-implemented method. The training datasets may be approximate measurements or derived from an empirical model or from simulations of a theoretical or a computational model, which may be one-dimensional or multi-dimensional model. Non-limiting examples of theoretical or computational models that can be used for simulating sound transmission through conventional multi-panel structures include finite element analysis, transfer matrix method, statistical energy analysis, plane wave models, mass-law models, and combinations thereof. Similarly, the material properties of conventional multi-panel structures may be obtained from literature, measured using experiments, or derived from theoretical or computational models. In the computer-implemented method of some embodiments, the material properties and target values of sound transmission loss and sound transmission ratings may be only approximate values for the first and the second training datasets. In some embodiments, target values of sound transmission loss and sound transmission ratings may be derived from simulation of one-dimensional model lumped-parameter applied to single panel or double panel or multi-panel structures. In some embodiments, the one-dimensional lumped-parameter model may be selected from a group consisting of transfer-matrix method, plane-wave model, statistical energy model, mass-law model, empirical model, and combinations thereof.

In some embodiments, for the first and second training datasets, the material properties comprise respective thickness, bulk density, elastic modulus, damping ratio, Poisson's ratio, air flow resistivity, and porosity of a plurality of multi-panel structures. For the first and the second training datasets, the target values of sound transmission loss may be provided at various frequencies, which comprise a plurality of one-third octave frequencies ranging between about 20 Hz to about 8000 Hz. For the second training dataset, the target values of the sound transmission ratings may be derived in a preprocessing step for a plurality of one-third octave frequencies ranging between about 20 Hz to about 8000 Hz.

In some embodiments of the computer-implemented method, the target values of sound transmission loss may be provided at a plurality of center frequencies of one-third octave bands between about 20 Hz to about 20,000 Hz. In more preferred embodiments, the target values of sound transmission loss may be provided at a plurality of center frequencies of one-third octave bands between about 20 Hz to about 8000 Hz.

In some embodiments, the first and the second training datasets may further comprise a plurality of input features having a format of arrays selected from a group consisting of text strings, numeric vectors, categorical vectors, images, videos, audio signals, and combinations thereof. The preprocessing of the first and the second training datasets further comprises feature engineering algorithms selected from a group consisting of transformer models, large language models, auto-encoders, generative adversarial networks, diffusion models, convolutional neural networks, target encoders, principal component analysis, singular vector decomposition, wavelet transforms, Fourier descriptors, clustering, and combinations thereof.

In some embodiments, at step (710-2), the preprocessing of the second training dataset may further include generating sound transmission ratings from the sound transmission loss values for the multi-panel structures. In preferred embodiments, sound transmission ratings may be standard ratings selected from a group consisting of outdoor-indoor transmission class

(OITC), sound transmission class (STC), apparent sound transmission class (ASTC), impact insulation class (IIC), and combinations thereof. In more preferred embodiments, weighted sound transmission ratings may be used and may be generated by weighting and aggregating the sound transmission loss values. The weighting of the sound transmission loss values may comprise subtracting the sound transmission loss from a reference spectrum value and then adding human auditory response weight, such as A-weighting, at the corresponding sound frequencies incident on the multi-panel structures. A non-limiting example of weighted sound transmission rating used in a preferred embodiment is outdoor-indoor transmission class (OITC) rating, prescribed by the ASTM E1332-10A (included herein by reference). The sound transmission rating, for some embodiments, may be modified to include an expanded or modified frequency weighting range than that prescribed by the standard test methods, including but not limited to those from ASTM and ISO. In some embodiments, wherein the sound transmission rating is the OITC rating, it may be expanded to include low frequencies less than 50 Hz and high frequencies greater than 5000 Hz and may range from about 20 Hz to about 8000 Hz. In some embodiments, the A-weighting for frequencies used in OITC rating may be modified to include frequencies lower than about 50 Hz and frequencies greater than about 5000 Hz. In some embodiments, the reference spectrum intensities for frequencies used in OITC rating may be modified to include frequencies lower than about 50 Hz and frequencies greater than about 5000 Hz. Without being limited by any one theory, it is believed that the modification of OITC rating by the broadening the incident frequency spectrum, modifying the reference spectrum intensities, and changing the A-weighting during the preprocessing may enable improvements of sound transmission loss of the embodiments at very low and very high frequencies not generally included for testing or modeling the conventional multi-panel structures. It is anticipated that the improvements may be due to enabling the second artificial intelligence model to learn the unexpected behaviors, such as increased transmission effects because of resonance corresponding to very low incident frequencies or interaction between the panels and the absorbers of multi-panel structures at very low and very high incident frequencies.

In some embodiments, at step (710-3), during the preprocessing of the second training dataset, the normalized sound transmission rating may be calculated from the weighted sound transmission rating using the following expression: 10·log₁₀ [10^{(Tw/10)}/bw], wherein ‘Tw’ is the weighted sound transmission rating and ‘bw’ is the total basis weight of the multi-panel structure, wherein the total basis weight is defined as a sum of products of bulk density and thickness of each panel and absorber of the multi-panel structure. Without being limited by any one theory, it is believed that the normalization of weighted sound transmission rating by the basis weight may help in accounting for the bulk density and thickness effects of the panels and absorbers to block the sound. It is also anticipated that the normalization may help to create an objective function that accounts for both the sound blocking performance and the cost defined by the bulk density and thickness of panels and absorbers. By including the objective function (normalized sound transmission rating) as a target variable it is believed that the second artificial intelligence model may learn how material factors affect both performance and cost of multi-panel structures, and store the learned behavior in the second trained model object. Because the objective function of the third machine learning optimization algorithm comprises the second trained model object, it is anticipated to help maximize sound blocking performance at the lowest cost.

At step 716, in some embodiments, the third training dataset may comprise the processed second training dataset from the second artificial intelligence model. The material properties included in the third training dataset may be only those that have high relative importance derived from the second output dataset of results from the second artificial intelligence model. In some embodiments, the material properties included in the third training dataset may have relative importance in the 50th percentile, more preferably in 75th percentile, and even more preferably in 90th percentile.

In some embodiments, at step 718, a first set of constraints is provided to the third machine learning optimization model. The first set of constraints for optimization may comprise a formulation that may be derived from user-defined range of values, functions, and ratios of the plurality of material properties of the multi-panel structures. The material properties included in the constraints may comprise those selected from the third training dataset. In some embodiments, at step 720, the objective function for the third machine learning optimization model may be constructed as a functional form comprising the second trained model object and the first set of constraints. The functional form may have hyperparameters that may be user-defined or tuned during the optimization process. Non-limiting examples of hyperparameters include coefficients, constants, and Lagrange multipliers. The functional form may be selected from a group consisting of linear functions, non-linear functions, probability functions, differential functions, integral functions, discrete functions, and combinations thereof. The objective function may be set up with a goal to maximize the modeled normalized sound transmission rating. At step 722, in some embodiments, the third machine learning optimization algorithm may be selected from gradient descent, evolutionary algorithms, genetic programming, particle swarm optimization, simulated annealing, Bayesian optimization, Newton's method, conjugate gradient, Nelder-Mead algorithm, linear programming, and combinations thereof. Non-limiting example of the third machine learning optimization model described by steps 716-726 may be the one referenced in the “Definitions” section. Without being limited by an theory, it is believed that by maximizing the objective function, the normalized sound transmission rating may be maximized more than what may be possible through experimentation because by including the most impactful material properties in the constraints, the optimization may be maximizing the learned performance and cost behavior latent in the second trained model object from the second artificial intelligence model.

At step 728, in some embodiments, a second set of constraints is provided to the fourth generative artificial intelligence model. The second set of constraints may combine the first set of constraints from the third machine learning optimization model with the constraints defined by co-occurrence of material properties of the multi-panel structure. A fourth training dataset may be used for the fourth generative artificial intelligence model, and this training dataset may be selected from the first training dataset, the second training dataset, the third training dataset, or a combination thereof. The co-occurrence probabilities of material properties may be derived from the fourth training dataset. In some embodiments, the co-occurrence constraints may comprise a formulation that may be derived from user-defined range of values, functions, and ratios of co-occurrence probabilities of material properties. The co-occurrence probabilities may be calculated for two or more material properties. In some embodiments, co-occurrence probabilities may be calculated for four material properties, more preferably for three materials properties, and even more preferably for two material properties. In some embodiments, multiple sets of co-occurrence probabilities may be included in the second set of constraints. Non-limiting examples of material properties of the panels for which co-occurrence probabilities may be calculated include bulk density, elastic modulus, Poisson's ratio, and damping ratio. Non-limiting examples of material properties of the absorbers for which co-occurrence probabilities may be calculated include bulk density, elastic modulus of the solid part, Poisson's ratio of the solid part, solid volume fraction, and air flow resistivity. The material properties of the panels and the absorbers may be binned first and then the co-occurrence of binned properties may be calculated from the fourth training dataset. The co-occurrence probabilities may form the joint probability distribution of the material properties in the fourth training dataset. In some embodiments, to obtain material properties on the fringe or even outside of joint probability distributions of that in the fourth training dataset, the constraint formulation may be set to have co-occurrence probabilities of at least some properties outside the 90% range, more preferably 95% range, and even more preferably 99% range defined by the fourth training dataset.

In some embodiments, at step 730, the fourth generative artificial intelligence algorithm may be selected from variational auto-encoders, generative adversarial networks, transformer models, diffusion models, recurrent neural networks, Metropolis-Hastings algorithm, simulated annealing, genetic algorithms, reinforcement learning, Monte-Carlo simulation, and combinations thereof. Non-limiting example of the fourth generative artificial intelligence model described by steps 728-730 may be the one referenced in the “Definitions” section. The fourth generative artificial intelligence algorithm may generate material properties of the panels and the absorbers in the neighborhood of the training data distribution guided by the second set of constraints. In some embodiments, the generated material properties may be within one-standard deviation of the mean, more preferably within two-standard deviations of the mean, and even more preferably within three-standard deviations of the mean material properties values of the fourth training dataset. In some embodiments, some of the generated material properties may be outside three-standard deviations, more preferably outside four-standard deviations, and even more preferably outside five-standard deviations of the mean material property values in the fourth training dataset. The probability of the generated material properties may be calculated from empirical cumulative distribution functions (ECDF) of the material properties of the multi-panel structures in the fourth training dataset. Using the generated material properties of the panels and the absorbers, at step 734, the optimized values of the modeled normalized sound transmission ratings are calculated using the second trained model object. Without being limited by any one theory, it is believed that by defining the second set of constraints using the co-occurrence probability values of the material properties, the fourth generative artificial intelligence model may result in generation of novel material property combinations. It is anticipated that the novel material property combinations may decouple the material properties coupled in the fourth training dataset and results in generation of meta-materials of the embodiments, in general. In a non-limiting example, the generated material properties of the panels may have high damping ratio despite having high elastic modulus and high bulk density, which may be coupled in the fourth training dataset. It is believed that in this non-limiting example, the presence of high damping ratio may only be possible if the material of the panel is a meta-material.

For the embodiments of the computer-implemented method, large amounts of records in the first and the second training datasets may be needed. The number of multi-panel structure designs for which material properties and target values are acquired in the first and the second training datasets may be greater than about 5,000 designs, more preferably greater than about 10,000 designs, and even more preferably greater than about 20,000 designs. The number of incident sound frequencies for which target values of sound transmission loss are available in the first training dataset may be greater than about 10 frequencies, more preferably greater than about 20 frequencies, and even more preferably greater than about 25 frequencies. The total number of records in the first training dataset may be greater than about 50,000 records, more preferably greater than about 200,000 records, and even more preferably greater than about 500,000 records. The total number of records in the second training dataset may be greater than about 5,000 records, more preferably greater than about 20,000 records, and even more preferably greater than about 25,000 records.

In some embodiments, the first and second artificial intelligence algorithms applied in steps (704) and (712), respectively, further comprise, the computer-implemented method may include performing one or more additional steps. One such additional step (704-4) may include selecting a regression algorithm from a group consisting of generalized linear regression, polynomial regression, support vector regression, decision tree regression, random forest regression, gradient boosting regression, extreme gradient boosting regression, light gradient boosting machine regression, neural network regression, graph neural network regression, transformer regression, foundational models, and combinations thereof. In some embodiments, another step (704-5) may include configuring hyperparameters of the selected regression algorithm. In some embodiments, yet another step (704-6) may include training the first artificial intelligence model using the processed first training dataset and the selected regression algorithm with the configured hyperparameters to create the first trained model object capable of predicting modeled values of sound transmission loss at a plurality of sound frequencies incident on the multi-panel structures.

In some embodiments, step (712-3) may include selecting a regression algorithm from a group consisting of linear regression, polynomial regression, support vector regression, decision tree regression, random forest regression, gradient boosting regression, neural network regression, graph neural network regression, transformer regression, foundational models, and combinations thereof. In some embodiments, step (712-4) may include configuring hyperparameters of the selected regression algorithm. In some more embodiments, step (712-5) may include training the second artificial intelligence model using the processed second training dataset and the selected regression algorithm with the configured hyperparameters to create the second trained model object capable of predicting modeled normalized sound transmission ratings of the multi-panel structures.

In some embodiments, a computer program product may be stored on a non-transitory computer-readable storage medium. The computer program product may comprise instructions that, when executed by a processor, may cause the processor to perform the steps of the method described in FIGS. 7A through 7C. In some embodiments, a system may comprise of components to execute the computer-implemented method described in FIGS. 7A through 7C. The components may comprise a processor, a memory, and an access to a data storage unit for reading and writing datasets.

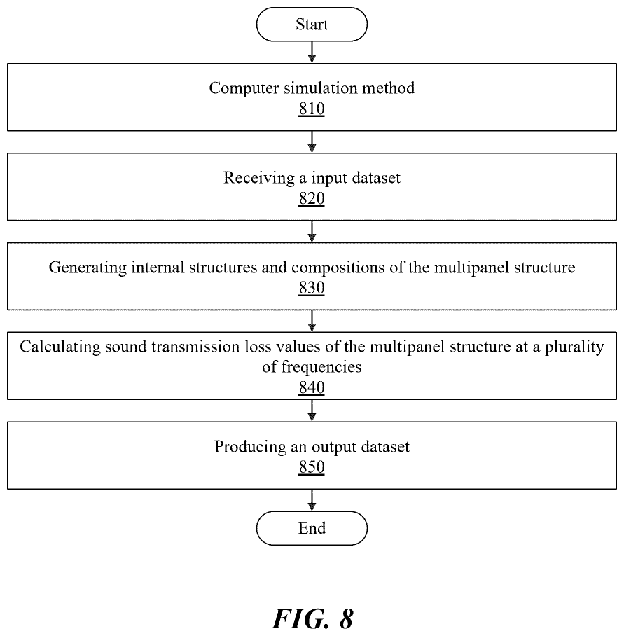

FIG. 8 is a flowchart that further describes the computer simulation method 810 for designing a multi-panel structure from FIG. 7A, according to some embodiments of the present disclosure. In some embodiments, at step 820, the computer simulation method may include receiving an input dataset comprising the fourth output dataset of FIGS. 7A through 7C and user-provided settings for the multi-panel structure to be created. At step 830, the computer simulation method may include generating internal structures and compositions of the multi-panel structure utilizing the input dataset. At step 840, the computer simulation method may include calculating sound transmission loss values of the multi-panel structure at a plurality of frequencies utilizing a method selected from a group consisting of finite element analysis, transfer matrix method, statistical energy analysis, plane wave models, mass-law models, the first and the second artificial intelligence models described in FIGS. 7A through 7C, and combinations thereof. At step 850, the computer simulation method may include producing an output dataset comprising the internal structures and compositions of the multi-panel structure, and the sound transmission loss values of the multi-panel structure at a plurality of frequencies. The internal structures and compositions may be generated as vector representations and corresponding datasets comprising geometrical and material properties.

In some embodiments, a computer program product may be stored on a non-transitory computer-readable storage medium. The computer program product may comprise instructions that, when executed by a processor, may cause the processor to perform the steps of the method described in FIG. 8. In some embodiments, a system may comprise of components to execute the computer simulation method described in FIG. 8. The components may comprise a processor, a memory, and an access to a data storage unit for reading and writing datasets.

Without being limited by any one theory, it is believed that for designing a multi-panel structure of the general embodiments, patterns of interactions between its panels and absorbers may be captured using the first and the second artificial intelligence models. It is further believed that sufficient details about the patterns of interactions may be present even in the approximate experimental measurements or lumped-parameter models like mass-law model. By considering large amounts of the training data from individual panels and absorbers along with their combinations in multi-panel structures, the necessary details of the patterns of interactions may get embedded in the parameters and coefficients of the first and the second artificial intelligence models. It is anticipated that the third machine learning optimization model most likely determines a range of patterns of interactions that maximize the sound transmission loss. Furthermore, the third machine learning optimization model most likely range finds optimal material properties that may or may not be present in the first and the second training datasets of multi-panel structures. It is further believed that the fourth generative artificial intelligence model most likely generates novel material properties of panels and absorbers of multi-panel structures by incorporating optimized patterns of interactions and optimal material properties determined by the third machine learning optimization model. Through the combination of the optimal material properties and the optimal patterns of interactions, meta-material of the embodiments may be designed.

### Measurement Methods

“Bulk Density” or simple “density”, as used herein, of a solid material may be measured by one of the standard methods depending on the material of panels and absorbers. Non-limiting examples of standard methods to measure density include ASTM D792-20, ASTM D2395-17, ASTM D3748-14, ASTM C693-93, ASTM D3800-22, ASTM C271/C271M-16, ASTM C167-18, and ASTM C357-07, which are included herein by reference.

“Solid Volume Fraction” of an absorber, as used herein, may be calculated as apparent bulk density divided by solid bulk density. Apparent bulk density may be measured using the above-mentioned standard methods of measuring “bulk density”. Solid bulk density is defined as volume-averaged density of components used in making the absorber. The volume composition of the absorber may be determined using the ASTM E1131-20 (included herein by reference) method for thermo-gravimetric analysis of a material.

“Porosity” of an absorber, as used herein, is defined as void volume fraction of the absorber and may be calculated as (1−solid volume fraction).

“Elastic modulus” or “Young's Modulus”, as used herein, of a solid material may be measured by one of the standard methods depending on the material of panels and absorbers. Non-limiting examples of standard methods to measure density include ASTM C623-21, ASTM C1198-20, ASTM E1875-20a, ASTM C469/C469M-22, ASTM D7291/D7291M-22, ASTM E111-17, ASTM C1557-20, ASTM D3039, and ASTM D638, which are included herein by reference.

“Poisson's Ratio”, as used herein, of a solid material may be measured by one of the standard methods depending on the material of panels and absorbers. Non-limiting examples of standard methods to measure density include ASTM C623-21, ASTM C1198-20, ASTM E1875-20a, ASTM C469/C469M-22, ASTM E132-17, ASTM D6790/D6790M-22, and ASTM D303, which are included herein by reference.

“Damping Ratio” of a solid material, as used herein, may be measured by ASTM standard test method for measuring vibration-damping properties of materials, ASTM E756-05 (2017), which is included herein by reference.

“Air Flow Resistivity” of an absorber, as used herein, may be measured by ASTM standard test method for airflow resistance of acoustical materials, ASTM C522, which is included herein by reference.

“Sound Transmission Loss”, as used herein, of a multi-panel structure, a panel, or an absorber may be measured by ASTM standard test method for laboratory measurement of airborne sound transmission loss of building partitions and elements, ASTM E90-09, which is included herein by reference. In situations where ASTM E90-09 method cannot be used, another ASTM standard test method for laboratory measurement of airborne transmission loss of building partitions and elements using sound intensity, ASTM E2249-19 may be used. This method is also included herein by reference.

“Sound Transmission Loss Rating”, as used herein, of a multi-panel structure may be measured the ASTM Standard Classification for Rating Outdoor-Indoor Sound Attenuation, ASTM E1332-10A, which is included herein by reference.

### EXAMPLES

The present disclosure encompasses various embodiments and non-limiting examples that further illustrate the multi-panel structure and its sound attenuation capabilities.

### Example 1

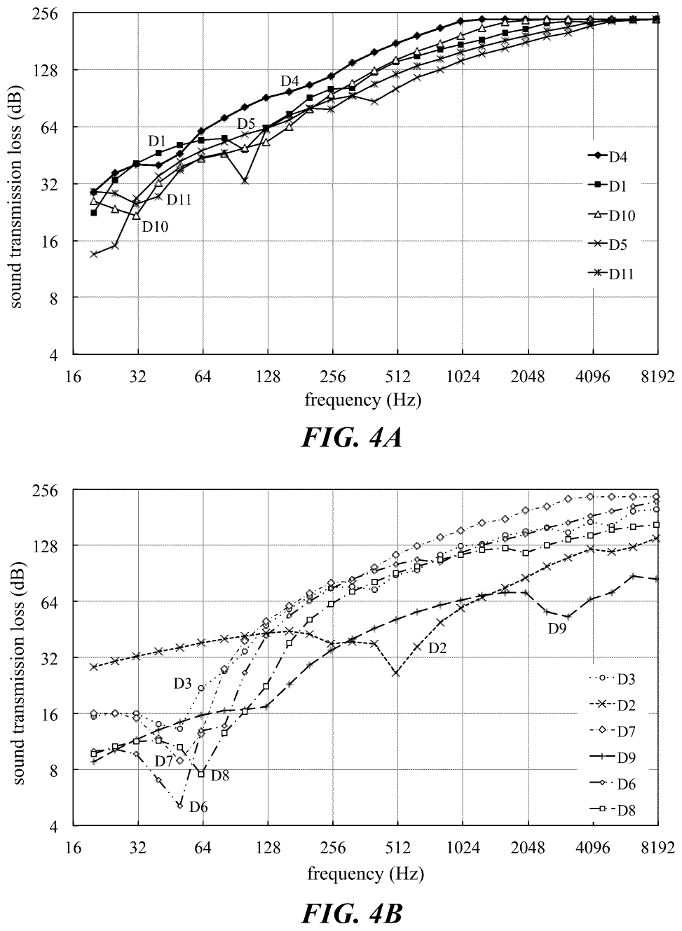

In this example, embodiments of a multi-panel structure comprise three panels and two absorbers. The embodiments also comprise a meta-material in either one of the 3 panels or in one of the 2 absorbers. The embodiments were generally designed using the computer-implemented method of the present disclosure. The first artificial intelligence model was a regression model using LightGBM algorithm applied on a first training dataset comprising 1.1 million records (obtained from a physics-based simulation model) of sound transmission loss values provided at one-third octave frequencies ranging from 20 Hz to 8000 Hz for over 40,000 multi-panel structures. The second artificial intelligence model was a regression model employing LightGBM algorithm on a second training dataset comprising 40,684 normalized OITC-ratings of multi-panel structure designs, obtained from a physics-based simulation model, available as Python code from “multipanel-stl-model” repository on GitHub, https://github.com/hora2015/multipanel-stl-model, which is included herein by reference. The third machine learning optimization model used was genetic algorithm, and the fourth generative artificial intelligence model was based on Metropolis-Hastings algorithm. The computer-implemented method was applied in the Dataiku Data Science Studio, v11.4.3, available from Dataiku Ltd., Paris, France. Based on the design specifications, the compositions were designed and developed in the AFMG Soundflow v1.0 software, available from AFMG Technologies GmbH, Germany. The compositions and design specifications are provided in the Table 1 and Table 2, respectively. FIG. 4A shows the sound transmission loss calculated for the multi-panel structures using physics-based model provided in the AFMG Soundflow v1.0 software.

TABLE 1

| ID | Panel 1 | Absorber 1 | Panel 2 | Absorber 2 | Panel 3 |
|---|---|---|---|---|---|
| D4 | Alumina | Feather light | Meta-Material: | Wood Fiber | Meta-Material: |
| | Ceramic Tiles | density | Recycled metal | Board | Recycled metal |
| | | fiberboard | swarf mixed with | | swarf mixed with |
| | | | minerals and PVC | | minerals and PVC |
| | | | composite, pressed | | composite, |
| | | | to densify | | pressed to densify |
| D1 | Concrete | Glass fiber | Meta-Material: | Mineral Wool | Fiber Cement |
| | | reinforced | Recycled steel and | | Board |
| | | urethane foam | copper shavings, | | |
| | | | steel wool | | |
| | | | combined in a | | |
| | | | medium density | | |
| | | | fiberboard | | |
| D10 | Meta- | Glass | Meta-Material: | Glass Wood | Meta-Material: |
| | Material: | reinforced | Steel wool mixed | fiber composite | Metal Fiber |
| | Metal | cork board | in gypsum or | | Urethane |
| | Polymer | | silicate matrix, | | Composite |
| | Composite | | pressed to densify | | |
| D5 | Slate Brick | Meta- | Cement Board | Composites | Fir wood |
| | Tile | Material: | | produced from | |
| | | Wood fibers | | cork, reinforced | |
| | | mixed with | | with glass | |
| | | steel wool | | fibers | |
| | | fibers | | | |
| D11 | Meta- | Resin bonded | Urethane | Glass Wood | Alumina |
| | Material: | Cork Board | Reinforced | fiber composite | Porcelain tile |
| | Metal Fiber | | Concrete | | |
| | Urethane | | | | |
| | Composite | | | | |

TABLE 2

| Designs | Units | D4 | D1 | D10 | D5 | D11 |
|---|---|---|---|---|---|---|
| Multi-panel structure type | | Triple | Triple | Triple | Triple | Triple |
| Occurrence Probability in Dataset | | 0 | 0.1 | 0 | 0.05 | 0 |
| Weighted Sound Transmission Rating | dB | 65 | 62 | 53 | 51 | 50 |
| AI Predicted Normalized Sound | | 34 | 37 | 32 | 34 | 32 |
| Transmission Rating | | | | | | |
| Physics-based Normalized Sound | | 37 | 34 | 26 | 27 | 21 |
| Transmission Rating | | | | | | |
| Total Basis Weight | kg/m² | 673 | 529 | 542 | 259 | 672 |
| Total Thickness | mm | 239 | 399 | 207 | 239 | 199 |

PANEL 1

| | | | | | | |
|---|---|---|---|---|---|---|
| Thickness | mm | 65 | 197 | 72 | 55 | 81 |
| Density | kg/m³ | 3600 | 1790 | 5750 | 3170 | 6230 |
| Elastic Modulus | GPa | 110 | 20 | 37 | 30 | 55 |
| Poisson's Ratio | | 0.2 | 0.15 | 0.45 | 0.27 | 0.46 |
| Damping Ratio | | 0.15 | 0.002 | 0.17 | 0.04 | 0.08 |

ABSORBER 1

| | | | | | | |
|---|---|---|---|---|---|---|
| Thickness | mm | 82 | 92 | 3 | 100 | 4 |
| Air Flow Resistivity | kPa-s/m² | 266 | 21.4 | 297 | 38 | 324 |
| Density | kg/m³ | 363 | 14 | 144 | 86 | 217 |
| Solid Density | kg/m³ | 486 | 1380 | 382 | 873 | 241 |
| Solid Elastic Modulus | GPa | 34 | 11 | 63 | 36 | 8 |
| Solid Poisson's Ratio | | 0.47 | 0.47 | 0.47 | 0.47 | 0.48 |
| Porosity | | 0.25 | 0.99 | 0.62 | 0.9 | 0.1 |

PANEL 2

| | | | | | | |
|---|---|---|---|---|---|---|
| Thickness | mm | 51 | 44 | 45 | 33 | 54 |
| Density | kg/m³ | 7040 | 3740 | 1480 | 1990 | 1750 |
| Elastic Modulus | GPa | 170 | 70 | 122 | 34 | 18 |
| Poisson's Ratio | | 0.23 | 0.3 | 0.18 | 0.32 | 0.45 |
| Damping Ratio | | 0.05 | 0.05 | 0.04 | 0.04 | 0.05 |

ABSORBER 2

| | | | | | | |
|---|---|---|---|---|---|---|
| Thickness | mm | 35 | 62 | 70 | 45 | 42 |
| Air Flow Resistivity | kPa-s/m² | 282 | 39 | 381 | 34 | 83 |
| Density | kg/m³ | 245 | 43 | 488 | 140 | 537 |
| Solid Density | kg/m³ | 520 | 3280 | 1724 | 335 | 1107 |
| Solid Elastic Modulus | GPa | 21 | 32 | 37 | 39 | 26 |
| Solid Poisson's Ratio | | 0.28 | 0.33 | 0.3 | 0.06 | 0.3 |
| Porosity | | 0.53 | 0.99 | 0.72 | 0.58 | 0.52 |

PANEL 3

| | | | | | | |
|---|---|---|---|---|---|---|
| Thickness | mm | 6 | 4.5 | 17 | 5 | 17 |
| Density | kg/m³ | 7003 | 1600 | 1664 | 547 | 2762 |
| Elastic Modulus | GPa | 185 | 31 | 101 | 14 | 19 |
| Poisson's Ratio | | 0.29 | 0.22 | 0.1 | 0.2 | 0.01 |
| Damping Ratio | | 0.12 | 0.02 | 0.15 | 0.01 | 0.08 |

### Comparative Example 1

In this comparative example, multi-panel structures are made of standard building materials. The multi-panel structures were generally designed using the computer-implemented method of the present disclosure, as described in the Example 1. The compositions and design specifications are provided in the Table 3 and Table 4, respectively. FIG. 4B shows the sound transmission loss calculated for the multi-panel structures using physics-based model provided in the AFMG Soundflow v1.0 software, available from AFMG Technologies GmbH, Germany.

TABLE 3

| ID | Panel 1 | Absorber 1 | Panel 2 | Absorber 2 | Panel 3 |
|---|---|---|---|---|---|
| D3 | Concrete | Polyurethane Foam | Plaster Board | Glass Fiber | Chipboard |
| | | | | Mat | |
| D2 | Composite | Air | Plywood | None | None |
| | rebar concrete | | | | |
| D7 | Hard PVC | Acetone- | Gypsum board | Polystyrene | Glass Plate |
| | | formaldehyde-resin | | Foam | |
| | | foam | | | |
| D9 | Reinforced | Polystyrene Foam | Gypsum board | None | None |
| | Polystyrene | | | | |
| | Board | | | | |
| D6 | Fir wood | Glass Wool | Fiber Cement | Basalt Fiber | Concrete |
| | | | Board | Felt | Board |
| D8 | Brickwork | Glass Wool | Aerated | Polyurethane | Fir wood |
| | | | Concrete | Foam | |
| | | | Board | | |

TABLE 4

| Designs | Units | D3 | D2 | D7 | D9 | D6 | D8 |
|---|---|---|---|---|---|---|---|
| Multi-panel structure type | | Triple | Double | Triple | Double | Triple | Triple |
| Occurrence Probability in | | 0.15 | 0.9 | 0.05 | 0.1 | 0.15 | 0.6 |
| Dataset | | | | | | | |
| Weighted Sound | dB | 37 | 36 | 32 | 29 | 28 | 27 |
| Transmission Rating | | | | | | | |
| Normalized Sound | | 17 | 10 | 12 | 13 | 11 | 11 |
| Transmission Rating | | | | | | | |
| Total Basis Weight | kg/m² | 109 | 398 | 111 | 34 | 53 | 44 |
| Total Thickness | mm | 241 | 175 | 240 | 74 | 198 | 160 |

PANEL 1

| | | | | | | | |
|---|---|---|---|---|---|---|---|
| Thickness | mm | 6 | 150 | 9 | 15 | 32 | 15 |
| Density | kg/m³ | 2430 | 2600 | 1300 | 1800 | 550 | 1600 |
| Elastic Modulus | GPa | 19 | 2 | 12 | 4.7 | 3.3 | 0.14 |
| Poisson's Ratio | | 0.3 | 0.3 | 0.3 | 0.3 | 0.3 | 0.3 |
| Damping Ratio | | 0.06 | 0.01 | 0.008 | 0.001 | 0.02 | 0.01 |

ABSORBER 1

| | | | | | | | |
|---|---|---|---|---|---|---|---|
| Thickness | mm | 100 | 10 | 100 | 50 | 75 | 45 |
| Air Flow Resistivity | kPa- | 5 | Air | 5 | 0.6 | 35 | 5 |
| | s/m² | | | | | | |
| Density | kg/m³ | 25 | 1.204 | 25 | 11.6 | 50 | 15 |
| Solid Density | kg/m³ | 1250 | 1.204 | 1250 | 1398 | 2525 | 2542 |
| Solid Elastic Modulus | GPa | 0.007 | Air | 0.007 | 3.2 | 69 | 69 |
| Solid Poisson's Ratio | | 0.49 | Air | 0.49 | 0.43 | 0.28 | 0.28 |
| Porosity | | 0.98 | Air | 0.98 | 0.99 | 0.98 | 0.99 |

PANEL 2

| | | | | | | | |
|---|---|---|---|---|---|---|---|
| Thickness | mm | 70 | 15 | 75 | 9 | 10 | 13 |
| Density | kg/m³ | 1200 | 562 | 700 | 680 | 1450 | 850 |
| Elastic Modulus | GPa | 8 | 1.9 | 4.5 | 3.3 | 8 | 0.6 |
| Poisson's Ratio | | 0.3 | 0.3 | 0.3 | 0.3 | 0.22 | 0.3 |
| Damping Ratio | | 0.003 | 0.01 | 0.02 | 0.02 | 0.01 | 0.05 |

ABSORBER 2

| | | | | | | | |
|---|---|---|---|---|---|---|---|
| Thickness | mm | 55 | NA | 50 | NA | 75 | 75 |
| Air Flow Resistivity | kPa- | 4 | NA | 400 | NA | 5 | 5 |
| | s/m² | | | | | | |
| Density | kg/m³ | 12 | NA | 600 | NA | 25 | 25 |
| Solid Density | kg/m³ | 2553 | NA | 1175 | NA | 1250 | 1250 |
| Solid Elastic Modulus | GPa | 69 | NA | 2.7 | NA | 0.01 | 0.01 |
| Solid Poisson's Ratio | | 0.28 | NA | 0.39 | NA | 0.49 | 0.49 |
| Porosity | | 0.99 | NA | 0.49 | NA | 0.98 | 0.98 |

PANEL 3

| | | | | | | | |
|---|---|---|---|---|---|---|---|
| Thickness | mm | 10 | NA | 6 | NA | 6 | 12 |
| Density | kg/m³ | 699 | NA | 2430 | NA | 2500 | 550 |
| Elastic Modulus | GPa | 2.1 | NA | 52 | NA | 21 | 4 |
| Poisson's Ratio | | 0.3 | NA | 0.3 | NA | 0.3 | 0.3 |
| Damping Ratio | | 0.008 | NA | 0.02 | NA | 0.06 | 0.01 |

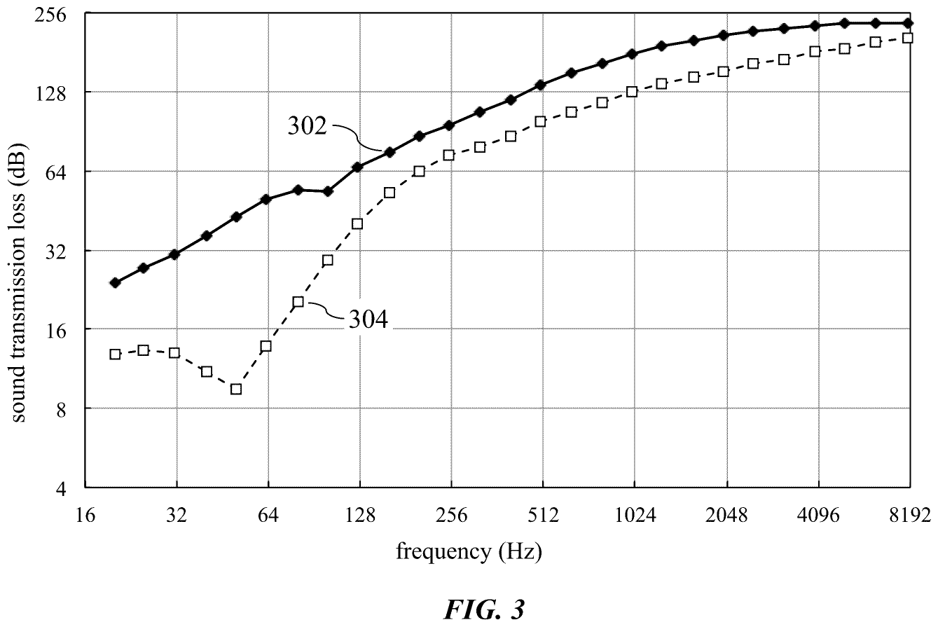

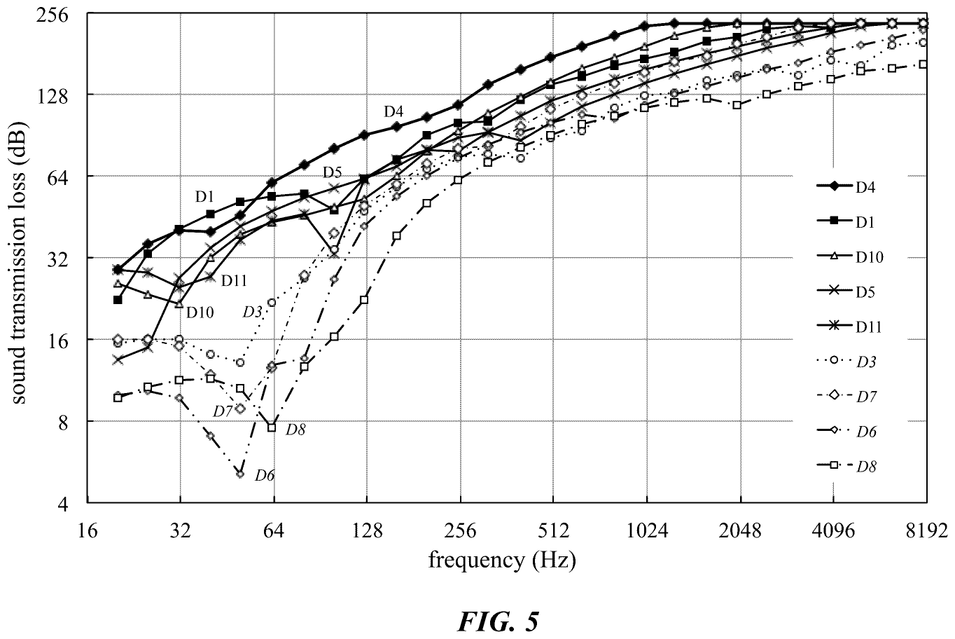

FIG. 3 is a plot showing a comparison of average values of sound transmission losses of embodiments 302 from Example 1 relative to those of standard multi-panel structures 304 from the Comparative Example 1. FIG. 5 is a plot showing a comparison of sound transmission loss values of all designs of the Example 1 relative to those of the Comparative Example 1. The results depicted in FIGS. 3 and 5 show that the sound transmission losses of the embodiments are statistically higher than those of the standard building materials. Similarly, the weights sound transmission loss ratings as well as normalized transmission loss ratings of the embodiments shown in Table 2 are statistically higher than those of the standard building materials-based multi-panel structures shown in Table 4. The results from these two examples indicate better performance of the embodiments relative to the standard building materials-based multi-panel structures.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “10 mm” is intended to mean “about 10 mm”.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All documents cited in the Detailed Description of the Invention are, in relevant part, incorporated herein by reference; the citation of any document is not to be construed as an admission that it is prior art with respect to the present disclosure. To the extent that any meaning or definition of a term in this written document conflicts with any meaning or definition of the term in a document incorporated by reference, the meaning or definition assigned to the term in this written document shall govern.

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this invention. The foregoing disclosure provides illustration and description but is not intended to be exhaustive or to limit the implementations to the precise form disclosed. Modifications may be made in light of the above disclosure or may be acquired from practice of the implementations. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A multi-panel structure for attenuating transmission of incident sound, the multi-panel structure comprising a plurality of panels and absorbers, wherein:
(i) the absorbers alternate between individual panels, and are fully enclosed between two consecutive panels;
(ii) the panels are substantially continuous and uninterrupted materials with substantially homogeneous physical properties at size scale of wavelength of the incident sound;
(iii) at least one of the panels comprises a meta-material comprising a metallic substance occupying at least 5% volume of the meta-material and a matrix substance occupying at least 10% volume of the meta-material;
(iv) the metallic substance of the meta-material is arranged in no particular arrangement, and spatial positioning of the metallic substance in the matrix substance is not predetermined;
(v) the absorbers comprise of a porous material consisting of a solid part and a fluid part;
(vi) the porous material of at least one of the absorbers is a meta-material consisting of a solid part and a fluid part; and
a combined thickness of the multi-panel structure is less than or equal to about 250 mm.

2. The multi-panel structure of claim 1 wherein the meta-material of the absorbers comprises a metallic substance occupying at least 1% of the volume of the meta-material, said metallic substance being arranged in no particular arrangement, and spatial positioning of the metallic substance in the meta-material is not predetermined.

3. The multi-panel structure according to claim 1 comprising three panels and two absorbers wherein:
(i) the three panels are designated as a first panel, a second panel, and a third panel;
(ii) the two absorbers are designated as a first absorber and a second absorber; and
(iii) the first absorber is fully enclosed between the first panel and the second panel, and
the second absorber is fully enclosed between the second panel and the third panel.

4. The multi-panel structure according to claim 2 wherein the metallic substance of the meta-material is selected from a group consisting of iron, steel, copper, aluminum, nickel, molybdenum, chromium, zinc, magnesium, manganese, tin, gold, silver, platinum, titanium, and alloys and mixtures thereof.

5. The multi-panel structure according to claim 2 wherein the metallic substance of the meta-material is embedded in the matrix substance, and is in a form selected from a group consisting of bars, rods, plates, wires, cables, fibers, filaments, ribbons, nonwoven or woven fabrics, foams, strands, chips, turnings, fillings, shavings, granules, powders, and combinations thereof.

6. The multi-panel structure according to claim 2 wherein the matrix substance of the meta-material is selected from a group consisting of glass, metal oxides, silica, gypsum, Portland cement, ceramics, wood, cellulose, sand, clay, wool, thermoplastic polymer, thermoset polymer, cross-linked polymer, and combinations thereof.

7. The multi-panel structure according to claim 6 wherein the thermoplastic polymer is selected from a group consisting of polyvinyl chloride, polyolefins, thermoplastic polyurethanes, polyethylene terephthalate, aliphatic polyesters, polyamides, polystyrenes, and blends, copolymers, and combinations thereof.

8. The multi-panel structure according to claim 6 wherein the thermoset polymer is selected from a group consisting of vulcanized rubber, bakelite, duroplast, phenol-formaldehyde resins, urea-formaldehyde resins, melamine-formaldehyde resins, epoxy resins, polyimides, silicone resins, cyanate esters, polyurethane resins, furan resins, vinyl ester resins, polyester resins, benzoxazines, and blends, copolymers, and combinations thereof.

9. The multi-panel structure according to claim 2 wherein:
(i) each of the panels has an average bulk density ranging between about 0.5 gram per cubic centimeter to about 8 grams per cubic centimeter, an average elastic modulus ranging between about 1 gigapascal to about 200 gigapascal, and an average damping ratio ranging between about 0.01 to about 0.25; and
(ii) each of the absorbers has an average bulk density ranging between about 0.01 gram per cubic centimeter to about 1 gram per cubic centimeter, a solid volume fraction ranging between about 0.01 and about 0.9, an average elastic modulus of the solid part ranging between about 1 gigapascal to about 200 gigapascal, and an average Poisson's ratio of the solid part ranging between about 0.25 and about 0.49.

10. The multi-panel structure according to claim 2 wherein either of the metallic substance or the matrix substance of the meta-material is a recycled material.

11. The multi-panel structure of claim 3 wherein:
(i) the second panel and the third panel comprise a meta-material wherein the metallic substance is an iron alloy, occupying at least about 85% of volume of the meta-material, and the matrix substance is polyvinyl chloride, occupying at least about 10% of volume of the meta-material;
(ii) the second panel and the third panel have an average bulk density ranging between about 6.8 grams per cubic centimeter to about 7.2 grams per cubic centimeter, an average elastic modulus ranging between about 170 gigapascal to about 190 gigapascal, and an average damping ratio ranging between about 0.05 to about 0.15; and
(iii) the combined thickness of the multi-panel structure is less than about 240 mm.

12. A computer-implemented method for designing a multi-panel structure to attenuate transmission of incident sound, utilizing a stack of models, comprising:
(i) a first artificial intelligence model, a second artificial intelligence model, a third machine learning optimization model, and a fourth generative artificial intelligence model, wherein the first and second artificial intelligence models utilize respective first and second training datasets obtained from an external database or experimental measurements;
(ii) the first artificial intelligence model comprising:
(a) receiving the first training dataset comprising a plurality of input features that comprise material properties of a plurality of multi-panel structures and a plurality of target values that comprise sound transmission loss values at a plurality of sound frequencies incident on the multi-panel structures;
(b) applying a first artificial intelligence algorithm to the first training dataset, comprising the steps of:
(b1) preprocessing the first training dataset into a processed first training dataset;
(b2) training the first artificial intelligence model using the processed first training dataset to create a first trained model object and predict modeled sound transmission loss values at a plurality of sound frequencies incident on the multi-panel structures;
(b3) determining a relative importance of the material properties that explain predictability of the modeled sound transmission loss values from the first artificial intelligence model;
(c) producing a first output dataset of results comprising the modeled sound transmission loss values and the relative importance of the material properties;
(iii) the second artificial intelligence model comprising:
(a) receiving the second training dataset comprising a plurality of input features that comprise material properties of a plurality of multi-panel structures and a plurality of target values that comprise sound transmission loss values at a plurality of sound frequencies incident on the multi-panel structures;
(b) preprocessing the second training dataset into a processed second training dataset using a set of most important material properties from the first output dataset, weighting and aggregating the sound transmission loss values to generate weighted sound transmission ratings, and normalizing the weighted sound transmission ratings by total basis weight of multi-panel structures to create normalized sound transmission ratings as the target values;
(c) applying a second artificial intelligence algorithm to the processed second training dataset, comprising the steps of:
(c1) training the second artificial intelligence model using the processed second training dataset to create a second trained model object and predict modeled normalized sound transmission ratings of the multi-panel structures;
(c2) determining a relative importance of the material properties that explain predictability of the modeled normalized sound transmission ratings from the second artificial intelligence model;
(d) producing a second output dataset of results comprising the modeled normalized sound transmission ratings of the multi-panel structures and the relative importance of the material properties;
(iv) the third machine learning optimization model comprising the steps of:
(a) receiving a third training dataset, comprising the processed second training dataset from the second artificial intelligence model;
(b) providing a first set of constraints, comprising a plurality of constraints on the material properties of the third training dataset;
(c) constructing an objective function, comprising the second trained model object and the first set of constraints;
(d) applying an optimization algorithm to maximize the objective function within the first set of constraints by changing values of the material properties in the third training dataset;
(e) obtaining maximized values of modeled normalized sound transmission ratings using the second trained model object and values of material properties utilized to maximize the objective function;
(f) producing a third output dataset of results comprising the maximized values of the modeled normalized sound transmission ratings and corresponding optimized material properties;
(v) the fourth generative artificial intelligence model comprising the steps of:
(a) providing a second set of constraints, comprising the constraints of the third machine learning optimization model and constraints defined by co-occurrence probabilities of material properties;
(b) generating a second set of optimized material properties in a neighborhood of the optimized material properties from the third output dataset by applying an artificial intelligence algorithm on the optimized material properties from the third output dataset and utilizing the second set of constraints;
(c) calculating occurrence probability values for the generated second set of optimized material properties relative to the processed second training dataset;
(d) determining optimized values of the modeled normalized sound transmission ratings corresponding to the generated second set of optimized material properties using the second trained model object; and
(e) producing a fourth output dataset of results comprising the generated second set of optimized material properties and their corresponding occurrence probability values, and the optimized values of the modeled normalized sound transmission ratings.

13. A computer-implemented method according to claim 12, wherein:
(i) for the first and second training datasets, the material properties comprise respective thickness, bulk density, elastic modulus, damping ratio, Poisson's ratio, air flow resistivity, and porosity of a plurality of multi-panel structures;
(ii) for the first training dataset, the target values of sound transmission loss are provided at a plurality of frequencies which comprise a plurality of one-third octave frequencies ranging between about 20 Hz to about 8000 Hz; and
(iii) for the second training dataset, the target values of the sound transmission ratings are derived for a plurality of one-third octave frequencies ranging between about 20 Hz to about 8000 Hz.

14. The computer-implemented method of claim 13, wherein:
(i) the first and the second training datasets further comprise a plurality of input features having a format of arrays selected from a group consisting of text strings, numeric vectors, categorical vectors, images, videos, audio signals, and combinations thereof;
(ii) the preprocessing of the first and the second training datasets further comprises feature engineering algorithms selected from a group consisting of transformer models, large language models, auto-encoders, generative adversarial networks, diffusion models, convolutional neural networks, target encoders, principal component analysis, singular vector decomposition, wavelet transforms, Fourier descriptors, clustering, and combinations thereof;
(iii) the weighting of the sound transmission loss values in the preprocessing of the second training dataset comprises subtracting the sound transmission loss from a reference spectrum value and then adding human auditory response weight at the corresponding sound frequencies incident on the multi-panel structures; and
(iv) the normalized sound transmission rating in the preprocessing of the second training dataset is calculated from the weighted sound transmission rating using a following expression: 10·log₁₀ [10^{(Tw/10)}/bw], wherein ‘Tw’ is the weighted sound transmission rating and ‘bw’ is the total basis weight of the multi-panel structure.

15. The computer-implemented method of claim 13, wherein the first and second artificial intelligence algorithms applied in steps (b) and (c), respectively, further comprise:
(b4) selecting a regression algorithm from a group consisting of generalized linear regression, polynomial regression, support vector regression, decision tree regression, random forest regression, gradient boosting regression, extreme gradient boosting regression, light gradient boosting machine regression, neural network regression, graph neural network regression, transformer regression, foundational models, and combinations thereof;
(b5) configuring hyperparameters of the selected regression algorithm;
(b6) training the first artificial intelligence model using the processed first training dataset and the selected regression algorithm with the configured hyperparameters to create the first trained model object capable of predicting modeled values of sound transmission loss at a plurality of sound frequencies incident on the multi-panel structures;
(c3) selecting a regression algorithm from a group consisting of linear regression, polynomial regression, support vector regression, decision tree regression, random forest regression, gradient boosting regression, neural network regression, graph neural network regression, transformer regression, foundational models, and combinations thereof;
(c4) configuring hyperparameters of the selected regression algorithm; and
(c5) training the second artificial intelligence model using the processed second training dataset and the selected regression algorithm with the configured hyperparameters to create the second trained model object capable of predicting modeled normalized sound transmission ratings of the multi-panel structures.

16. A computer program product stored on a non-transitory computer-readable storage medium, the computer program product comprising instructions that, when executed by a processor, cause the processor to perform the steps of the method according to claim 13.

17. A system comprising components to execute the computer-implemented method of claim 13, wherein the components comprise a processor, a memory, and an access to a data storage unit for reading and writing datasets.

18. A computer simulation method utilizing the computer-implemented method of claim 13 to create a multi-panel structure for attenuating transmission of incident sound, the computer simulation method comprising:
(i) receiving an input dataset comprising the fourth output dataset and user-provided settings for the multi-panel structure to be created;
(ii) generating internal structures and compositions of the multi-panel structure utilizing the input dataset, wherein the internal structures and compositions are generated as vector representations and corresponding datasets comprising geometrical and material properties;
(iii) calculating sound transmission loss values of the multi-panel structure at a plurality of frequencies utilizing a method selected from a group consisting of finite element analysis, transfer matrix method, statistical energy analysis, plane wave models, mass-law models, the first and the second artificial intelligence models, and combinations thereof; and
(iv) producing an output dataset comprising the internal structures and compositions of the multi-panel structure, and the sound transmission loss values of the multi-panel structure at a plurality of frequencies.

19. A computer program performing the computer simulation method according to claim 18, wherein the computer program is stored on a non-transitory computer-readable storage medium.

20. A system comprising components to execute the computer simulation method of claim 18, wherein the components comprise a processor, a memory, and an access to a data storage unit for reading and writing datasets.
